(19) United States
(12) Patent Application Publication
(10) Pub. No.: US 2025/0251309 A1
(43) Pub. Date: Aug. 7, 2025

(54) FAULT DETERMINING METHOD OF RECIPROCATING DEVICE AND PORT CONTROL METHOD

(71) Applicant: YANTAI JEREH OILFIELD SERVICES GROUP CO., LTD., Yantai (CN)

(72) Inventors: Xinmeng WANG, Yantai (CN); Shuai SU, Yantai (CN); Dezheng LIU, Yantai (CN); Zongwen WANG, Yantai (CN)

(73) Assignee: YANTAI JEREH OILFIELD SERVICES GROUP CO., LTD., Yantai (CN)

(21) Appl. No.: 19/187,495

(22) Filed: Apr. 23, 2025

Related U.S. Application Data
(63) Continuation of application No. PCT/CN2023/087678, filed on Apr. 11, 2023.

(51) Int. Cl. G01M 13/028; G05B 23/02

(52) U.S. Cl. CPC G01M 13/028; G05B 23/0243; G05B 23/0283

(57) ABSTRACT

This application provides a fault determining method of a reciprocating device and a port control method. The method includes: obtaining target signal data acquired by a sensor located on a component at a predetermined location of a reciprocating device; determining, according to a data type of the target signal data, a target processing mode; processing, according to the target processing mode, the target signal data, to obtain a running status eigenvalue reflecting a running status of the component; and determining, according to the running status eigenvalue, a fault result indicating whether the component is faulty. The present disclosure solves a technical problem that it is unlikely to accurately determine a fault of a reciprocating device in the related art.

### CROSS-REFERENCE TO RELATED APPLICATIONS

This application is a continuation of and claims the benefit of priority to PCT International Patent Application No. PCT/CN2023/087678, filed on Apr. 11, 2023, and entitled “RECIPROCATING APPARATUS FAULT DETERMINATION METHOD AND PORT CONTROL METHOD,” which is incorporated herein by reference in its entirety.

### TECHNICAL FIELD

The present disclosure relates to the field of reciprocating devices, and particularly, to a fault determining method of a reciprocating device and a port control method.

### BACKGROUND

A reciprocating device is used in various working conditions such as cementing, souring, and fracturing in oil and gas fields. As a core device in the production of the oil and gas fields, the safety, reliability, and stability of the reciprocating device directly affect the operational efficiency of the oil field. A fault of the reciprocating device causes large economic and safety losses. Therefore, it is crucial to promptly determine whether the reciprocating device is faulty and address the issue as soon as it occurs. In the existing art, however, it is unlikely to accurately determine a fault result indicating whether the reciprocating device is faulty. For the foregoing problem, no effective solution has been provided at present.

### SUMMARY

An objective of the embodiments of this application is to solve a technical problem that it is unlikely to accurately determine a fault of a reciprocating device in the related art.

According to an aspect of the embodiments of the present disclosure, a fault determining method of a reciprocating device includes:
obtaining target signal data, acquired by a sensor located on a component at a predetermined location of a reciprocating device;
determining, according to a data type of the target signal data, a target processing mode;
processing, according to the target processing mode, the target signal data, to obtain a running status eigenvalue reflecting a running status of the component; and
determining, according to the running status eigenvalue, a fault result indicating whether the component is faulty.

According to an aspect of the embodiments of the present disclosure, a fault determining method of a reciprocating device includes:
obtaining:
target data of the reciprocating device corresponding to a target strain association indicator within a target stage in a current working status, and
predetermined data of the reciprocating device corresponding to the target strain association indicator within the target stage in a predetermined working status,
where the target stage includes at least one a compression stage and an expansion stage;
determining, according to the target data and the predetermined data, a target deviation value;
comparing the target deviation value with a predetermined deviation threshold determined according to the target stage, to obtain a target deviation comparison result; and
obtaining, according to the target deviation comparison result and a target comparison relationship representing a comparison relationship between a deviation comparison result and a fault determining result, a target fault determining result indicating whether the reciprocating device is faulty.

According to an aspect of the embodiments of the present disclosure, a fault determining method of a reciprocating device includes:
obtaining:
target key-phase data including target key-phase signal value, and
target vibration data of at least one cycle of a reciprocating device, where the target vibration data is acquired by a sensor located on a component at a predetermined location of the reciprocating device;
determining, according to the target key-phase data, a first comparison relationship configured for representing a corresponding relationship between time and a key-phase signal value;
determining, according to the target vibration data and the first comparison relationship, a second comparison relationship configured for representing a corresponding relationship between an angle by which an internal gear of the reciprocating device rotates and an amplitude of the component at the predetermined location;
determining, according to the second comparison relationship, an angle-domain histogram and an angle-domain envelope diagram corresponding to the reciprocating device;
determining:
a target number of columnar objects having height values exceeding a predetermined threshold in the angle-domain histogram, and
a target envelope area in the angle-domain envelope diagram; and
determining, according to the target number and the target envelope area, a fault result indicating whether the reciprocating device is faulty.

According to an aspect of the embodiments of the present disclosure, a port control method includes:
receiving a predetermined operation of a target object on a target control in an operation interface, where:
the operation interface displays reciprocating device data corresponding to a plurality of port groups and controls controlling ports within the plurality of port groups, and
the port group includes a target module port corresponding to a target module inserted into a target device and a virtual module port corresponding to a measurement device connected to the target module;
determining, in response to the predetermined operation, a target port group corresponding to the target control and a target control instruction for controlling the target port group; and
transmitting the target control instruction to the target port group.

According to an aspect of the embodiments of the present disclosure, an electronic device includes:
a processor; and
a memory configured to store instructions executable by the processor,
where the processor is configured to execute the instructions, to implement the fault determining method of the reciprocating device according to any of the foregoing and the port control method according to any of the foregoing.

According to an aspect of the embodiments of the present disclosure, a computer-readable storage medium includes, when instructions in the computer-readable storage medium are executed by a processor of an electronic device, the electronic device is caused to perform the fault determining method of the reciprocating device according to any of the foregoing and the port control method according to any of the foregoing.

In the embodiments of the present disclosure, target signal data is obtained, where the target signal data is acquired by a sensor located on a component at a predetermined location of a reciprocating device. Then, a target processing mode is determined according to a data type of the target signal data. After that, the target signal data is processed according to the target processing mode, to obtain a running status eigenvalue reflecting a running status of the component at the predetermined location of the reciprocating device. Finally, according to the running status eigenvalue, a fault result indicating whether the component at the predetermined location of the reciprocating device is faulty is determined.

Since the target signal data is acquired by the sensor located on the component at the predetermined location of the reciprocating device, the obtained target signal data may accurately reflect a situation of the component at the predetermined location of the reciprocating device. A specific target processing mode may be determined according to the data type of the target signal data. The target signal data is processed according to the specific target processing mode, to quickly obtain an accurate running status eigenvalue reflecting the running status of the component at the predetermined location of the reciprocating device. According to the running status eigenvalue, the fault result indicating whether the component at the predetermined location of the reciprocating device is faulty may be accurately determined, thereby achieving a technical effect of determining the fault result indicating whether the component at the predetermined location of the reciprocating device is faulty in a specific mode, and further solving a technical problem that it is unlikely to accurately determine a fault of a reciprocating device in the related art.

### BRIEF DESCRIPTION OF THE DRAWINGS

The accompanying drawings described herein are intended to provide further understanding of the present disclosure and constitute a part of this application. Exemplary embodiments of the present disclosure and the description thereof are configured for explaining the present disclosure rather than constituting the improper limitation to the present disclosure. In the accompanying drawings:

FIG. 1 is an example flowchart of a first fault determining method of a reciprocating device according to an embodiment of the present disclosure;

FIG. 2 is an example functional diagram of status monitoring and fault diagnosis according to an optional implementation of the present disclosure;

FIG. 3 is an example schematic diagram of a data processing procedure according to an optional implementation of the present disclosure;

FIG. 4 is an example schematic diagram of a location of a vibration sensor according to an optional implementation of this application;

FIG. 5 is an example schematic diagram of a location of a key-phase sensor according to an optional implementation of this application;

FIG. 6 is an example schematic diagram of a coded disk according to an optional implementation of this application;

FIG. 7 is an example flowchart of a second fault determining method of a reciprocating device according to an embodiment of the present disclosure;

FIG. 8 is an example flowchart of a method according to an optional implementation of the present disclosure;

FIG. 9 is an example schematic diagram of preprocessing a key-phase signal according to an optional implementation of the present disclosure;

FIG. 10 is an example schematic diagram of a relation curve of a target strain association indicator and time according to an optional implementation of the present disclosure;

FIG. 11 is an example schematic diagram of a rule tree model according to an optional implementation of the present disclosure;

FIG. 12 is an example flowchart of a third fault determining method of a reciprocating device according to an embodiment of the present disclosure;

FIG. 13 is an example reciprocating device test-key-phase signal diagram according to an optional implementation of this application;

FIG. 14 is an example reciprocating device test-angle-domain vibration diagram according to an optional implementation of this application;

FIG. 15 is an example reciprocating device test-angle-domain histogram according to an optional implementation of the present disclosure;

FIG. 16 is an example reciprocating device test-angle-domain envelope diagram according to an optional implementation of the present disclosure;

FIG. 17 is an example reciprocating device test-angle-domain vibration diagram in a fault case according to an optional implementation of this application;

FIG. 18 is an example reciprocating device test-angle-domain histogram in a fault case according to an optional implementation of this application;

FIG. 19 is an example reciprocating device test-angle-domain envelope diagram in a fault case according to an optional implementation of the present disclosure;

FIG. 20 is an example flowchart of a port control method according to an embodiment of the present disclosure;

FIG. 21 is an example structural block diagram of a port control system according to an embodiment of the present disclosure;

FIG. 22 is an example connection architecture diagram according to an optional embodiment of the present disclosure;

FIG. 23 is an example schematic diagram of a multi-terminal connection according to an optional embodiment of the present disclosure;

FIG. 24 is an example structural block diagram of a first fault determining apparatus of a reciprocating device according to an embodiment of the present disclosure;

FIG. 25 is an example structural block diagram of a second fault determining apparatus of a reciprocating device according to an embodiment of the present disclosure;

FIG. 26 is an example structural block diagram of a third fault determining apparatus of a reciprocating device according to an embodiment of the present disclosure; and

FIG. 27 is an example structural block diagram of a port control apparatus according to an embodiment of the present disclosure.

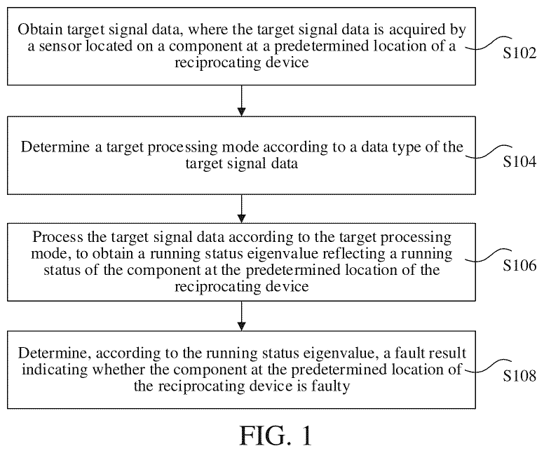

### DETAILED DESCRIPTION

To make a person skilled in the art understand the solutions in the present disclosure better, the following describes the technical solutions in the embodiments of the present disclosure with reference to the accompanying drawings in the embodiments of the present disclosure. The described embodiments are merely examples. All other embodiments obtained by a person of ordinary skill in the art based on the embodiments of the present disclosure shall fall within the protection scope of the present disclosure.

It should be noted that the terms “first”, “second”, etc. in the specification and claims of the present disclosure and in the foregoing drawings are configured for distinguishing between similar objects and not necessarily for describing a particular sequence or sequential order. It will be appreciated that data so used are interchangeable under appropriate circumstances, whereby the embodiments of the present disclosure described herein can be implemented in orders other than those illustrated or described herein. The terms “include”, “have”, and any other variants mean to cover the non-exclusive inclusion, for example, a process, method, system, product, or device that includes a list of steps or units is not necessarily limited to those expressly listed steps or units, but may include other steps or units not expressly listed or inherent to such a process, method, system, product, or device.

Some of the nouns or terms appearing in the process of describing the embodiments of this application are to be construed as follows:

Reciprocating Device: The reciprocating device is composed of a reduction gearbox, a power end, and a fluid end. The power end drives the reduction gearbox through a coupling. The reduction gearbox is directly connected to a crankshaft of the power end, and drives the crankshaft to rotate. The crankshaft drives, through a connecting rod and a cross head, a piston or a plunger to move reciprocally in a cylinder of the fluid end. Under alternate actions of a suction valve and a discharge valve, purposes of high-pressure pumping and cyclical acting are achieved.

Target Strain Association Indicator: The indicator is an indicator associated with a strain. The target strain association indicator in this application includes a strain, a micro-strain, a stress, a pressure, and a pressure intensity.

### Embodiment 1

According to this embodiment of the present disclosure, an embodiment of a fault determining method of a reciprocating device is provided. It should be noted that the steps shown in the flowcharts of the drawings may be performed in a computer system, such as a set of computer-executable instructions, and that, although a logical sequence is shown in the flowcharts, the steps shown or described may be performed in a sequence other than that described herein in some cases.
Step S102: Obtain target signal data, where the target signal data is acquired by a sensor located on a component at a predetermined location of a reciprocating device.

In step S102, since the target signal data is acquired by the sensor located on the component at the predetermined location of the reciprocating device, the obtained target signal data may accurately reflect a situation of the component at the predetermined location of the reciprocating device.
Step S104: Determine a target processing mode according to a data type of the target signal data.

In step S104, a specific target processing mode may be determined according to the data type of the target signal data.
Step S106: Process the target signal data according to the target processing mode, to obtain a running status eigenvalue reflecting a running status of the component at the predetermined location of the reciprocating device.

In step S106, the target signal data is processed according to the specific target processing mode, to quickly obtain an accurate running status eigenvalue reflecting the running status of the component at the predetermined location of the reciprocating device.
Step S108: Determine, according to the running status eigenvalue, a fault result indicating whether the component at the predetermined location of the reciprocating device is faulty.

In step S108, according to the running status eigenvalue, a fault result indicating whether the component at the predetermined location of the reciprocating device is faulty may be accurately determined.

According to the foregoing steps S102 to S108, target signal data is obtained, where the target signal data is acquired by a sensor located on a component at a predetermined location of a reciprocating device. Then, a target processing mode is determined according to a data type of the target signal data. After that, the target signal data is processed according to the target processing mode, to obtain a running status eigenvalue reflecting a running status of the component at the predetermined location of the reciprocating device. Finally, according to the running status eigenvalue, a fault result indicating whether the component at the predetermined location of the reciprocating device is faulty is determined.

Since the target signal data is acquired by the sensor located on the component at the predetermined location of the reciprocating device, the obtained target signal data may accurately reflect a situation of the component at the predetermined location of the reciprocating device. A specific target processing mode may be determined according to the data type of the target signal data. The target signal data is processed according to the specific target processing mode, to quickly obtain an accurate running status eigenvalue reflecting the running status of the component at the predetermined location of the reciprocating device. According to the running status eigenvalue, the fault result indicating whether the component at the predetermined location of the reciprocating device is faulty may be accurately determined, thereby achieving a technical effect of determining the fault result indicating whether the component at the predetermined location of the reciprocating device is faulty in a specific mode, and further solving a technical problem that it is unlikely to accurately determine a fault of a reciprocating device in the related art.

As an optional embodiment, after processing the target signal data according to the target processing mode, to obtain a running status eigenvalue reflecting a running status of the component at the predetermined location of the reciprocating device, the method further includes: processing the running status eigenvalue by reduction of dimensionality, to obtain a use duration eigenvalue reflecting a remaining use duration of the component at the predetermined location of the reciprocating device; and determining the remaining use duration of the component at the predetermined location of the reciprocating device according to the use duration eigenvalue.

In this embodiment, the running status eigenvalue is processed by reduction of dimensionality, so that a use duration eigenvalue reflecting a remaining use duration of the component at the predetermined location of the reciprocating device may be quickly obtained. The remaining use duration of the component at the predetermined location of the reciprocating device may be accurately determined according to the use duration eigenvalue. A fault of the reciprocating device can be avoided by using the remaining use duration.

As an optional embodiment, the step of processing the target signal data according to the target processing mode, to obtain a running status eigenvalue reflecting a running status of the component at the predetermined location of the reciprocating device includes: converting, in a case that the target signal data includes key-phase data and vibration time-domain signal data, the data type of the target signal data includes a key-phase data type and a vibration time-domain signal data type, and the target processing mode is a predetermined data type conversion processing mode, the vibration time-domain signal data, to obtain vibration angle-domain signal data in which a data type is a vibration angle-domain signal data type; and obtaining, according to the key-phase data and the vibration angle-domain signal data, the running status eigenvalue reflecting the running status of the component at the predetermined location of the reciprocating device.

In this embodiment, in a case that the target signal data includes key-phase data and vibration time-domain signal data, the data type of the target signal data includes a key-phase data type and a vibration time-domain signal data type, and the target processing mode is a predetermined data type conversion processing mode, the vibration time-domain signal data is converted, so that accurate vibration angle-domain signal data in which a data type is a vibration angle-domain signal data type may be obtained. The running status eigenvalue reflecting the running status of the component at the predetermined location of the reciprocating device, which is obtained according to the key-phase data and the accurate vibration angle-domain signal data, is accurate.

As an optional embodiment, the step of processing the target signal data according to the target processing mode, to obtain a running status eigenvalue reflecting a running status of the component at the predetermined location of the reciprocating device includes: inputting, in a case that the target processing mode is a model processing mode, the target signal data to a status detection model, to obtain the running status eigenvalue reflecting the running status of the component at the predetermined location of the reciprocating device, where the status detection model is obtained by training an initial model by using sample data, and the sample data includes: sample signal data and a sample running status eigenvalue.

In this embodiment, since the sample data includes: sample signal data and a sample running status eigenvalue, a status detection model obtained by training an initial model by using the sample data may accurately obtain the sample running status eigenvalue according to the sample signal data. Therefore, in a case that the target processing mode is a model processing mode, the target signal data is inputted to the status detection model, so that a proper running status eigenvalue reflecting the running status of the component at the predetermined location of the reciprocating device may be quickly and accurately obtained.

As an optional embodiment, the step of processing the target signal data according to the target processing mode, to obtain a running status eigenvalue reflecting a running status of the component at the predetermined location of the reciprocating device includes: determining a difference distribution between the target signal data and a predetermined baseline space in a case that the target processing mode is a baseline space processing mode; and obtaining, according to the difference distribution, the running status eigenvalue reflecting the running status of the component at the predetermined location of the reciprocating device.

In this embodiment, a difference distribution between the target signal data and a predetermined baseline space may be determined in a case that the target processing mode is a baseline space processing mode. According to the difference distribution, the obtained running status eigenvalue may accurately reflect the running status of the component at the predetermined location of the reciprocating device.

As an optional embodiment, the step of obtaining, according to target digital signal data, a running status eigenvalue reflecting a running status of a unit includes: filtering, in a case that the target digital signal data includes vibration frequency signal data and the target processing mode is a filtering processing mode, the vibration frequency signal data according to a predetermined mode, to obtain the running status eigenvalue reflecting the running status of the component at the predetermined location of the reciprocating device, w here the predetermined mode includes a band-pass filtering mode and a windowing function filtering mode.

In this embodiment, in a case that the target digital signal data includes vibration frequency signal data and the target processing mode is a filtering processing mode, the vibration frequency signal data may be filtered according to a predetermined mode, to quickly obtain an accurate running status eigenvalue reflecting the running status of the component at the predetermined location of the reciprocating device.

As an optional embodiment, the sensor located on the component at the predetermined location of the reciprocating device includes at least one of the following: a first vibration sensor located on a rotating component of the reciprocating device, a second vibration sensor located on a crankcase bearing housing of the reciprocating device, a temperature-vibration integral sensor located in a cross head load region of the reciprocating device, a key-phase sensor located on a power end crankshaft of the reciprocating device and/or a rotating component linked to the power end crankshaft, and a pressure sensor located on a gland of the reciprocating device.

In this embodiment, the sensor located on the component at the predetermined location of the reciprocating device may include at least one of the following: a first vibration sensor located on a rotating component of the reciprocating device, a second vibration sensor located on a crankcase bearing housing of the reciprocating device, a temperature-vibration integral sensor located in a cross head load region of the reciprocating device, a key-phase sensor located on a power end crankshaft of the reciprocating device and/or a rotating component linked to the power end crankshaft, and a pressure sensor located on a gland of the reciprocating device. Sensors corresponding to the performance are arranged at the locations, so that corresponding data may be accurately obtained.

Based on the foregoing embodiments and optional embodiments, an optional implementation is provided, which is described below in detail.

An optional implementation of the present disclosure provides a fault determining method of a reciprocating device, which can determine a fault result indicating whether a component is faulty at a predetermined location of the reciprocating device in a specific mode.

To implement the fault determining method of the reciprocating device in this application, a status monitoring and fault diagnosis system of a reciprocating device in this application includes: a sensor unit, an edge computing unit, and a server monitoring and diagnosis unit.

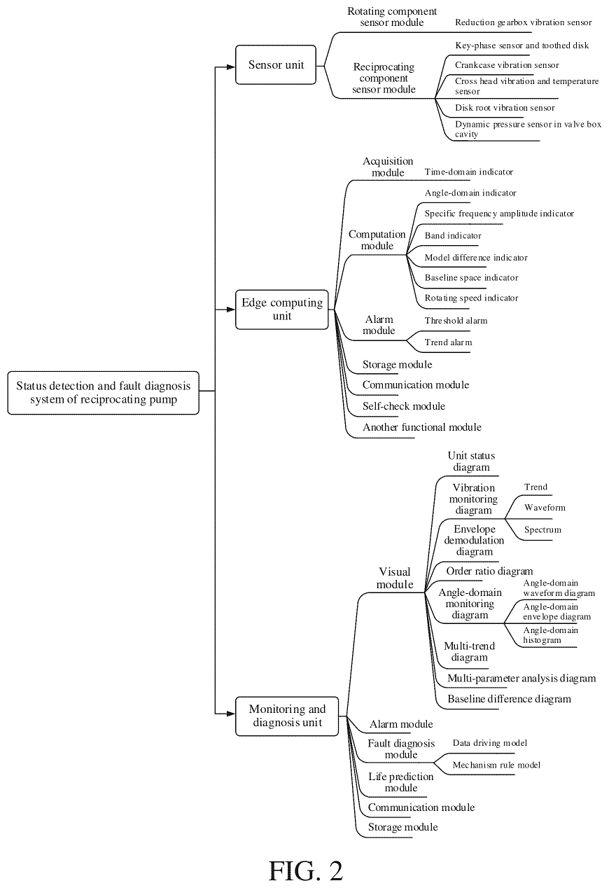

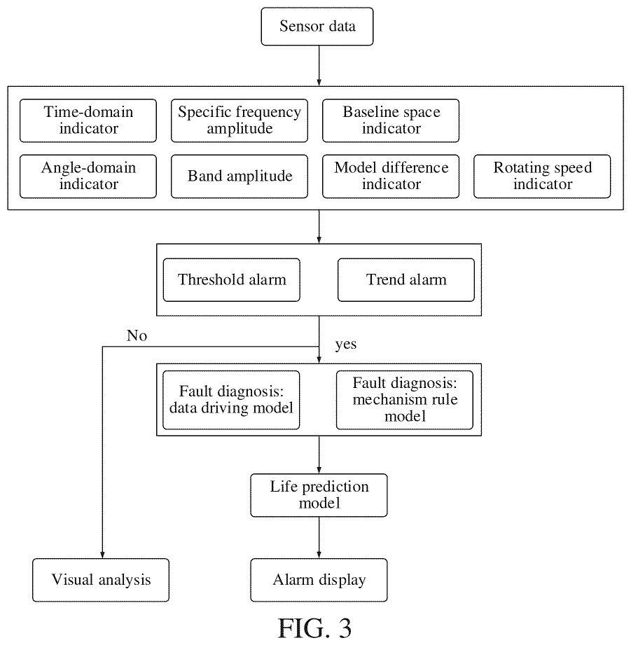

FIG. 2 is an example functional diagram of status monitoring and fault diagnosis according to an optional implementation of the present disclosure, and FIG. 3 is an example schematic diagram of a data processing procedure according to an optional implementation of the present disclosure.

### 1. Sensor Unit

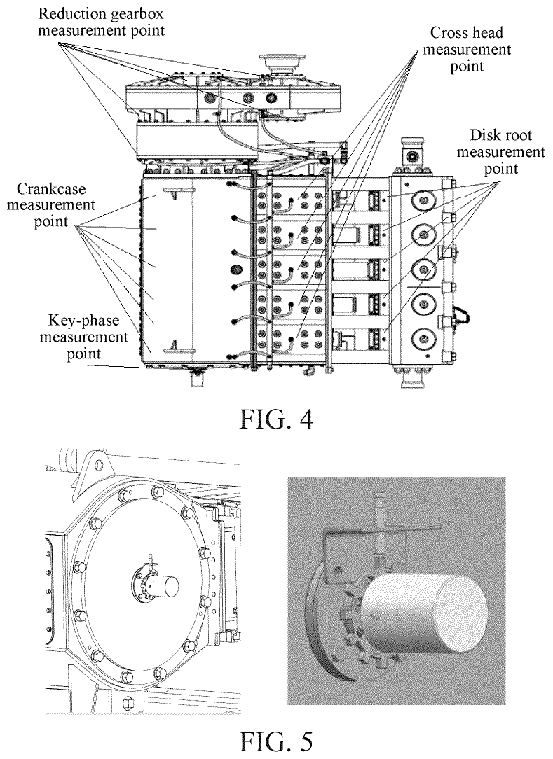

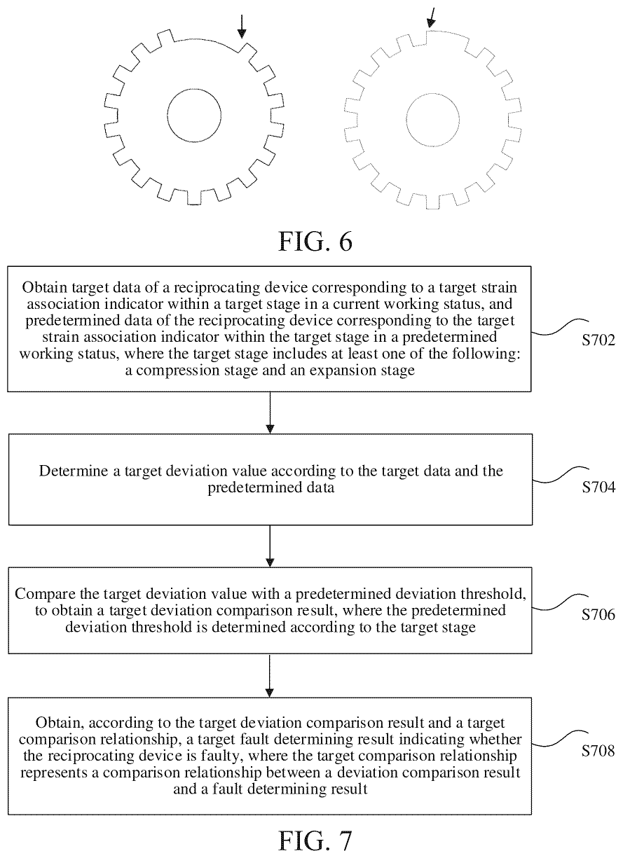

Vibration, temperature, noise, and the like are always generated during running of a mechanical device. When there is a fault risk in a running component, physical parameters such as vibration, temperature, and noise usually change to some extent. Corresponding sensors are mounted to monitor and analyze the change of the physical parameters in real time. According to a situation of a transmission chain of the reciprocating device, the sensor unit includes: a rotating component sensor module and a reciprocating component sensor module. The rotating component sensor module may include a vibration sensor. The reciprocating component sensor module includes a key-phase sensor and a toothed disk, a vibration transmission sensor, a temperature sensor, a pressure sensor, and the like.
(1) The vibration sensor in the rotating component sensor module is mounted on a radial portion and an axial portion of each bearing housing of the reduction gearbox (or another rotating component) by threading or magnetic attraction. FIG. 4 is an example schematic diagram of a location of a vibration sensor according to an optional implementation of this application.
(2) The key-phase toothed disk in the reciprocating component sensor module is mounted on the crankshaft of the power end or the rotating component connected to the crankshaft, and rotates and moves with the crankshaft. The key-phase sensor is mounted, by using a bracket, on the crankshaft of the power end or a support component connected to the crankshaft, and does not rotate and move with the crankshaft, as shown in FIG. 5. FIG. 5 is an example schematic diagram of a location of a key-phase sensor according to an optional implementation of this application. A key-phase toothed disk (equivalent to a coded disk) has N teeth, where (N−1) teeth are evenly distributed, and an angle between the teeth is 360°/N. The remaining tooth has a different shape. To be specific, the tooth may be concave or convex. FIG. 6 is an example schematic diagram of a coded disk according to an optional implementation of this application. The tooth is configured to define a zero-point location, which is briefly referred to as a zero-point tooth. By using this method, a rotation speed of a crankshaft may be obtained, a rotation angle of the crankshaft (the angle is associated with a stroke of a piston) may be obtained, and the obtained angle value is used as a horizontal coordinate to calibrate a change situation of another signal (such as vibration, temperature, and pressure). It should be noted that the rotation speed and the angle may be obtained by mounting an encoder.

One cylinder is at a top-dead-center location by turning, and the zero-point tooth is precisely aligned with the key-phase sensor. Since an angle difference between the cylinders is fixed, each cylinder has a zero-point angle reference when acquiring a sensor signal.
(3) The vibration sensor in the reciprocating component sensor module is mounted on a radial portion and an axial portion of a crankcase bearing housing, a cross head load region, and a vertical direction of a disk root cavity by threading or magnetic attraction, as shown in FIG. 4.
(4) The temperature sensor in the reciprocating component sensor module is mounted in the cross head load region by threading or magnetic attraction, and monitors the temperature of a cross head component. Alternatively, a temperature-vibration integral sensor may be used, as shown in FIG. 4.
(5) The pressure sensor in the reciprocating component sensor module is mounted on a gland by threading, to monitor a real-time dynamic pressure inside a valve box cavity.

### 2. Edge Computing Unit

The edge computing unit acquires data of the sensor unit, and then performs functions such as computation, alarm, storage, and transmission, to implement real-time monitoring of a running status of a unit. The edge computing unit includes: an acquisition module, a computation module, an alarm module, a storage module, a communications module, a self-check module, and the like.
(1) Acquisition Module: An acquisition mode, a sampling frequency, the number of sampling points, a sensor type, sensor sensitivity, and the like are set, to acquire analog signals of a plurality of sensors, convert the analog signals into digital signals, and compute time-domain feature indicators (such as an effective value, a maximum value, a minimum value, an average value, an average amplitude, a peak value, a kurtosis value, a distortion value, a square amplitude, a peak factor, a pulse factor, a waveform factor, and a margin factor) of the signals. An analog-digital conversion precision of an acquisition channel is not less than 24 bits. Multi-channel synchronous acquisition is supported, spacing acquisition is supported, and acquisition is triggered by using a rotation speed or a feature indicator. A sampling frequency of each acquisition channel is not less than 16384 Hz.

For example, for the sensor unit, the sampling frequency is set to 25600 Hz, the number of sampling points is set to 102400, the sensor sensitivity is set to 100 mv/g, and acquisition is synchronously performed at an interval of 60 seconds. The acquisition is triggered when the rotation speed of the crankshaft is greater than 10 or a vibration eigenvalue is greater than 1 mm/s.

2. Computation Module: A Series of Transformation and Computation are Performed on a Signal, to Obtain an Eigenvalue. There are Mainly Five Types:
time-domain feature indicators of a cross head and a disk root vibration sensor signal are extracted in stages according to a crankshaft rotation angle of 0° to 360°.

For example, according to a zero-point location of the key-phase signal, a full cycle vibration signal of one work cycle of a 1V measurement point at a 1 cylinder disk root is extracted. By using an interpolation algorithm, equally spaced vibration time-domain signals are converted into equally spaced vibration angle-domain signals. A n angle-domain effective value is computed according to every 10° or another angle in stages.

A corresponding motor rotation frequency, a reduction gearbox parallel level rotation frequency, a reduction gearbox planet level rotation frequency, a crankshaft rotation frequency, a reduction gearbox mesh frequency, and a bearing fault feature frequency are computed based on a transmission chain transmission ratio and a bearing model and according to a crankshaft rotation speed. Fast Fourier transform (FFT) is performed on reduction gearbox and crankcase vibration sensor signals to obtain a frequency-domain signal, windowing function filtering is performed on the frequency-domain signal according to the foregoing frequencies, and a corresponding frequency eigenvalue is obtained by computation on the filtered signal.

Filtering is performed according to different frequency bands to compute eigenvalues of the different frequency bands.

For example, an analysis frequency of an original signal is 12800 Hz, and after band-pass filtering is performed according to 0-2 Hz, 2-1000 Hz, and 1000-12800 Hz, a corresponding frequency band eigenvalue is computed. The frequency of 0-2 Hz mainly reflects whether the sensor generates a ski slope and whether the sensor works normally. The frequency of 2-1000 Hz mainly reflects a low-frequency fault of the unit, such as unbalance or misalignment. The frequency of 1000-12800 Hz mainly reflects a high-frequency fault of the unit, such as wear of a bearing and a gear.

Based on normal unit signals collected in a laboratory or a working site, a probability statistics model (e.g. a deep convolutional auto-encoder model) is constructed. A signal is inputted to the model, to obtain a model output. A difference between the model output and the signal is used as an eigenvalue, to reflect a running status of the unit.

Based on normal unit signals collected in a laboratory or a working site, a probability distribution space in a time-domain or a frequency domain, which is briefly referred to as a baseline space, is constructed. A signal is inputted to the baseline space, to obtain a difference distribution between the input signal and the baseline space, and the difference distribution is computed to obtain an eigenvalue, to reflect the running status of the unit. For example, a vibration signal inputted in the reduction gearbox and having a normal 1H measurement point is collected, to construct a frequency-domain baseline space. A to-be-tested frequency-domain signal is inputted. When an amplitude of a frequency is less than an amplitude corresponding to the baseline space, it is set to zero, or when the amplitude of the frequency is greater than the amplitude corresponding to the baseline space, a difference is displayed.
(3) Alarm Module: A threshold alarm, a trend alarm, and the like are performed on the eigenvalue generated by the acquisition module and the computation module, and alarm levels include: normal, early-alarm, alarm, and high-alarm.

Threshold Alarm: Different level alarm thresholds are set according to an ISO standard, a manufacturer standard, or an eigenvalue distribution (a quantile or a standard deviation) of normal working of the unit. When the eigenvalue exceeds a set threshold, different levels of alarms occur. For example, according to an ISO10816-6 vibration standard, an early-alarm threshold of a 1H measurement point vibration signal inputted in the reduction gearbox is set to 11.2 mm/s. An alarm threshold is 17.8 mm/s, and a high-alarm threshold is 28.2 mm/s. When the signal is less than 11.2 mm/s, the vibration is normal.

Trend Alarm: It is divided into a rapid-changing trend alarm and a slow-changing trend alarm.

Rapid-Changing Trend Alarm: Whether a trend of the eigenvalue rises within 30 minutes of a time cycle or another time cycle and whether a value of a rising slope exceeds a set threshold are determined.

Slow-Changing Trend Alarm: Whether a trend of the eigenvalue rises within 3 months of a time cycle or another time cycle and whether a value of a rising slope exceeds a set threshold are determined.
(4) Storage Module: Data of the acquisition module, the computation module, and the alarm module is stored, which satisfies a data capacity of at least 6 months or another cycle. A data dilution policy is permanent storage of alarm data. Normal data is significantly diluted according to a time cycle such as year, month, day, or hour, to ensure that there is data within each time cycle. Longer time indicates more diluted data.
(5) Communication Module: A standard communication protocol or a self-defined protocol is used, including a hardware layer protocol, a network layer transmission protocol, an application layer protocol, and the like. Data transmission and exchange between different information systems (such as a programmable logic controller (PLC)) and between different units and modules within the system are implemented.
(6) Self-Check Module: The module has power failure self-recovery, self-diagnosis of a sensor, a cable, and an acquisition unit, and online firmware upgrade. For example, a bias voltage of an acceleration sensor is approximately 12 V. When the bias voltage is equal to 0 V or 24 V, it indicates that a sensor or a connection cable is faulty.
(7) Another Functional Module: The module has a time synchronization function with a satellite clock server, to ensure time synchronization of the devices.

### 3. Server Monitoring and Diagnosis Unit

The server monitoring and diagnosis unit performs functions such as feature conversion and fault diagnosis on data transmitted by the edge computing unit, to determine a fault of a unit and predict a remaining life of the faulty unit. The server monitoring and diagnosis unit includes: a visual analysis module, an alarm module, a fault diagnosis module, a life prediction module, a communications module, and a storage module.
(1) Visual Analysis Module: Signal processing and feature transformation are performed on an original signal, to obtain professional graph data, helping an engineer to perform fault diagnosis on the unit. The module mainly includes the following functions:

Unit Status Diagram: Real-time running statuses of reciprocating devices and subcomponents are displayed, where the statuses include: normal, early-alarm, alarm, and high-alarm.

Vibration Monitoring Diagram: A trend, a waveform, and a spectrum of real-time and historical eigenvalues of each vibration measurement point are displayed.

Envelope Demodulation Diagram: A high-frequency resonance response wave generated by a fault impact is amplified, and is changed into a low-frequency waveform having fault feature information by using an envelope wave detection method. Then, a feature frequency of the fault is found by using a spectrum analysis method.

Order Ratio Diagram: With reference to key-phase data, a time-domain waveform sampled at equal time is converted into a time-domain waveform sampled at equal angles, and then Fourier transform and other transform are performed.

Angle-Domain Monitoring Diagram: A full-cycle signal, including an angle-domain waveform diagram, an angle-domain envelope diagram, and an angle-domain histogram, of each reciprocating measurement point is displayed.

Multi-Trend Diagram: Real-time and historical eigenvalue trends of status parameters such as a rotation speed, vibration, pressure, and temperature are displayed.

Multi-Parameter Analysis Diagram: A full-cycle vibration waveform, an intracavity pressure waveform, a cross head temperature, and the like that have the same horizontal coordinate are synchronously analyzed.

Baseline Space Diagram: A result of comparison and difference with a baseline space is displayed.
(2) Alarm Module: An alarm parameter is configured, alarm information and information such as a diagnosis result, a life prediction, or a repair recommendation are displayed, and the alarm information is eliminated or processed otherwise. A plurality of alarm modes such as sound-light alarm, short message alarm, and email alarm may be used.
(3) Fault Diagnosis Module: The alarm information is processed to obtain fault type determining and locating. Generally, a method based on a data-driven model, a method based on a mechanism rule model, and the like are used. It should be noted that the fault diagnosis module may be combined with the life prediction module to provide a service inspection recommendation.

The method based on a data-driven model includes: constructing a probability statistics model based on normal and fault case data, and using the model to perform fault prediction. For example, data preprocessing such as a missing value, an outlier, normalization, or one-hot is first performed on a normal sample and a faulty sample. Next, a relationship between a fault type and a sample is constructed by using the probability statistics model, for example, an algorithm such as a support vector machine, a random forest, or deep learning. Then fault prediction is performed by using the probability statistics model.

The method based on a mechanism rule model includes: extracting, based on a fault occurring mechanism, a corresponding feature indicator and symptom amount, and establishing a fault diagnosis rule by using a logical operation, a mathematical operation, or the like. For example, an original variable is first processed, to extract a feature indicator reflecting the running status of the unit. Next, a change pattern of the feature indicator within a period of time is extracted, to obtain a fault symptom. A result of a fault type is outputted for a plurality of fault symptoms by using weighted averaging, an If-then rule set, or the like. For example, the fault type is a fault of coupling misalignment.

| No. | Feature Indicator | Symptom Amount | Weight Value |
|---|---|---|---|
| 1 | Pass-band | s1: The frequency doubling | 0.3 |
| | effective value | amplitude occupies more than | |
| | | 75% of the pass-band value | |
| 2 | Fundamental | s2: The fundamental | 0.4 |
| | frequency | frequency amplitude increases | |
| | amplitude | as a load increases | |
| 3 | Frequency | s2: The frequency doubling | 0.4 |
| | doubling | amplitude increases as the | |
| | amplitude | load increases | |

If the rule confidence is 95%, a fault probability of “bad misalignment of coupling” = 95%*(0.3s1 + 0.4s2 + 0.4s3)

(4) Life Prediction Module: The remaining life of the device is evaluated based on data, such as fault type determining and locating, provided by the fault diagnosis.

Algorithm steps include: first, extracting a feature indicator set reflecting a running status of a device from the perspective of a fault mechanism and statistics, and performing operations such as dimensionality reduction on the indicator set, to obtain fewer feature indicators; next, establishing a trend curve of change of the feature indicator with a fault degree; then, constructing a relationship between a device running status and a remaining life by using a probability statistics model, such as regression, a proportional hazards regression model COX distribution, and a neural network; and finally, inputting the feature indicator, and outputting the remaining life by the life prediction model.
(5) Communication Module: A standard communication protocol or a self-defined protocol is used, including a hardware layer protocol, a network layer transmission protocol, an application layer protocol, and the like. Data transmission and exchange between different information systems (a PLC or a device management cloud platform) and between different units and modules within the system are implemented.
(6) Storage Module: Data generated by the edge computing unit and the monitoring and diagnosis unit is stored. A threshold parameter of the alarm module is stored. Model parameters of fault diagnosis and life prediction modules, and other data are stored.

By using the foregoing optional implementations, at least the following beneficial effects can be achieved:
(1) A fault result indicating whether a component at a predetermined location of a reciprocating device is faulty is determined in a specific mode.
(2) A running status of the reciprocating device is accurately mastered, a fault location and type are accurately predicted by using the running status, and a remaining life of a faulty unit is predicted.
(3) Real-time running statuses of the components of the reciprocating device are monitored and an alarm is given.
(4) Fault classification is performed according to alarm statuses of the components of the reciprocating device.
(5) The determined fault data is converted into a model, a result of model processing is outputted by using a visual interface, and a fault of each component of the reciprocating device is briefly and clearly presented.

FIG. 7 is an example flow chart of a second fault determining method of a reciprocating device according to an embodiment of the present disclosure. As shown in FIG. 7, the method includes the following steps.
Step S702: Obtain target data of a reciprocating device corresponding to a target strain association indicator within a target stage in a current working status, and predetermined data of the reciprocating device corresponding to the target strain association indicator within the target stage in a predetermined working status, where the target stage includes at least one of the following: a compression stage and an expansion stage.

In step S702, since the target data is data of the reciprocating device corresponding to the target strain association indicator within the target stage in the current working status, the target data may accurately reflect a situation of the reciprocating device in the current working status. Since the predetermined data is data of the reciprocating device corresponding to the target strain association indicator within the target stage in the predetermined working status, the predetermined data may accurately reflect a situation of the reciprocating device in the predetermined working status. To be specific, a normal working situation in which the reciprocating device has no fault may be accurately reflected.

It should be noted that a change of the target data of the reciprocating device in the compression stage and the expansion stage, i.e. in the target stage, may accurately reflect a current change situation of a pump valve in the reciprocating device, and the predetermined data of the reciprocating device in the target stage may accurately reflect a change situation of the pump valve in the reciprocating device in a normal case without a fault.

It should be further noted that the target strain association indicator includes a strain, a micro-strain, a stress, a pressure, and a pressure intensity. When the target strain association indicator is different, data corresponding to the target strain association indicator may be converted by using the following formula:

$$Pressure intensity = \vert stress \vert \times α . Stress = strain \times elasticity modulus . 1 Strain = 106 micro ‐ strain .$$

where α is a calibration error value, and both the calibration error value and the elasticity modulus are constant term coefficients. This application is effective for different target strain association indicators. To be specific, any one of a plurality of indicators included in the target strain association indicator may be selected as the target strain association indicator to perform the method in this application.
Step S704: Determine a target deviation value according to the target data and the predetermined data.

In step S704, since the target data is accurate and the predetermined data is accurate, an accurate target deviation value may be determined according to the target data and the predetermined data, and the target deviation value may accurately reflect a deviation between the current working status of the reciprocating device and the normal working status without a fault in the target stage.
Step S706: Compare the target deviation value with a predetermined deviation threshold, to obtain a target deviation comparison result, where the predetermined deviation threshold is determined according to the target stage.

In step S706, the target deviation value is compared with the predetermined deviation threshold determined according to the target stage, so that the target deviation comparison result may be quickly obtained, and the target deviation comparison result may reflect a comparison result between the deviation value of the data of the reciprocating device in the current working status and the data in the predetermined working status, i.e. in a normal case without a fault, and the predetermined deviation threshold.

It should be noted that in a case that the target deviation comparison result is that the target deviation value is greater than the predetermined deviation threshold, it indicates that a difference between the current status of the reciprocating device and the no-fault status is large. To be specific, it indicates that a fault may occur on the pump valve of the reciprocating device. In a case that the target deviation comparison result is that the target deviation value is less than or equal to the predetermined deviation threshold, it indicates that a difference between the current status of the reciprocating device and the no-fault status is small. To be specific, it may indicate that there is a relatively small possibility that a fault occurs on the pump valve of the reciprocating device.
Step S708: Obtain, according to the target deviation comparison result and a target comparison relationship, a target fault determining result indicating whether the reciprocating device is faulty, where the target comparison relationship represents a comparison relationship between a deviation comparison result and a fault determining result.

In step S708, since the target deviation comparison result is accurate, according to the target deviation comparison result and the target comparison relationship, whether the reciprocating device is faulty may be accurately determined according to the obtained target fault determining result indicating whether the reciprocating device is faulty, thereby achieving a technical effect of determining a fault of the reciprocating device.

According to the foregoing steps S702 to S708, target data of a reciprocating device corresponding to a target strain association indicator within a target stage in a current working status and predetermined data of the reciprocating device corresponding to the target strain association indicator within the target stage in a predetermined working status are obtained, where the target stage includes at least one of the following: a compression stage and an expansion stage. Then, a target deviation value is determined according to the target data and the predetermined data. After that, the target deviation value is compared with a predetermined deviation threshold, to obtain a target deviation comparison result, where the predetermined deviation threshold is determined according to the target stage. Finally, according to the target deviation comparison result and a target comparison relationship, a target fault determining result indicating whether the reciprocating device is faulty is obtained, where the target comparison relationship represents a comparison relationship between a deviation comparison result and a fault determining result. Since the target data is data of the reciprocating device corresponding to the target strain association indicator within the target stage in the current working status, the target data may accurately reflect a situation of the reciprocating device in the current working status. Since the predetermined data is data of the reciprocating device corresponding to the target strain association indicator within the target stage in the predetermined working status, the predetermined data may accurately reflect a situation of the reciprocating device in the predetermined working status. To be specific, a normal working situation in which the reciprocating device may have no fault is accurately reflected. Since the target data is accurate and the predetermined data is accurate, an accurate target deviation value may be determined according to the target data and the predetermined data, and the target deviation value may accurately reflect a deviation between the current working status of the reciprocating device and the normal working status without a fault in the target stage. Therefore, the target deviation value is compared with the predetermined deviation threshold determined according to the target stage, so that an accurate target deviation comparison result may be quickly obtained. Since the target deviation comparison result is accurate, according to the target deviation comparison result and the target comparison relationship, whether the reciprocating device is faulty may be accurately determined according to the obtained target fault determining result indicating whether the reciprocating device is faulty, thereby achieving a technical effect of determining a fault of the reciprocating device, and solving a technical problem that it is unlikely to accurately determine a fault of a reciprocating device in the related art.

It should be noted that it may be determined, by using the target deviation value, that a valve body of the reciprocating device opens early or opens later, to determine a specific gas valve fault status.

It should be further noted that the data corresponding to the target strain association indicator is relatively easy to obtain, and the data corresponding to the target strain association indicator and the target deviation value can quickly and accurately reflect a fault of the valve body in the reciprocating device. Therefore, the method in this application is very feasible and has a significant effect.

As an optional embodiment, the step of obtaining target data of a reciprocating device corresponding to a target strain association indicator within a target stage in a current working status includes: obtaining first key-phase data of the reciprocating device in the current working status and initial data corresponding to the target strain association indicator; preprocessing the initial data, to obtain first data, and preprocessing the first key-phase data, to obtain a target key-phase signal; determining a target index value according to the target key-phase signal; obtaining, according to the target index value and the first data, second data corresponding to a plurality of predetermined cycles, where each of the plurality of predetermined cycles includes: a compression stage, a discharge stage, an expansion stage, and a suction stage; and obtaining, according to second data corresponding to a target cycle, the target data of the reciprocating device corresponding to the target strain association indicator within the target stage in the current working status, where the target cycle is any of the plurality of predetermined cycles.

In this embodiment, a strain data acquisition system may be arranged on the reciprocating device. Initial data is acquired by using the strain data acquisition system. The strain data acquisition system includes a strain gage and a strain acquisition hardware apparatus. The strain data acquisition system may be mounted on a reciprocating pull rod in the reciprocating device. The reciprocating pull rod includes a cylinder rod, a plunger rod, and a pull rod. Since the strain data acquisition system may obtain, in real time, the initial data of the reciprocating device corresponding to the target strain association indicator in the current working status, accurate initial data may be acquired in time by using the strain data acquisition system. A key-phase signal acquisition system may be arranged on the reciprocating device, and first key-phase data is acquired by using the key-phase signal acquisition system. The key-phase signal acquisition system includes a key-phase sensor and an incomplete toothed disk wheel. The incomplete toothed disk wheel may be mounted on a crankshaft of the reciprocating device. Since the key-phase signal acquisition system may obtain the first key-phase data of the reciprocating device in the current working status in real time, accurate first key-phase data may be acquired in time by using the key-phase signal acquisition system.

Optionally, the initial data may be stored in a form of a matrix. For example, strain_data=[time, pass₁, pass₂, . . . , passₖ], where strain_data is a matrix structure of the initial data. Different rows of the matrix represent different time points, different columns of the matrix represent different cylinders of the reciprocating device, and matrix values are data of the reciprocating pull rod corresponding to the different cylinders, corresponding to the target strain association indicator at the different time points. To be specific, time is a data acquisition time point column, and passₖ is data of the reciprocating pull rod corresponding to a k^{th} cylinder, corresponding to the target strain association indicator. The data acquisition frequency of the initial data may be 51.2 kHz. First key-phase data is synchronously acquired when the initial data is acquired, and first key-phase data in different working conditions may be obtained. The first key-phase data may be stored in a form of a matrix. For example, keyphaseᵢ=[timeᵢ,keyᵢ], where keyphaseᵢ is a matrix structure of the first key-phase data, different rows of the matrix represent different time points, different columns of the matrix represent the first key-phase data, and matrix values are values of the first key-phase data at the different time points. keyᵢ represents a data column of first key-phase data corresponding to an i^{th} working condition. The data acquisition frequency of the first key-phase data may be 51.2 kHZ.

Optionally, the operation of preprocessing the initial data includes performing low-pass filtering on the initial data, to obtain pure data corresponding to the target strain association indicator. A Butterworth low-pass digital filter may be used for the low-pass filtering process. When the Butterworth low-pass digital filter is used, a cut-off frequency value W_n and a filter order N need to be set for a low-pass signal. The foregoing parameter may be a parameter having a better result in multiple groups of comparison experiments or may be set based on previous experience. First data may be obtained by preprocessing the initial data. The operation of preprocessing the first key-phase data includes standardizing the first key-phase data. For example, for first key-phase data keyphaseᵢ=[timeᵢ,keyᵢ], a statistical indicator of the data column keyᵢ is computed. The statistical indicator includes a quarter quantile, an average value, a three-quarter quantile, a mode, and a median. A value less than the statistical indicator in keyᵢ is 0, and a value greater than the statistical indicator is 1, to obtain a standardized key-phase signal data set keyphase_01ᵢ=[timeᵢ, key_01ᵢ]. To be specific, a target key-phase signal is obtained.

Optionally, when a target index value is determined according to the target key-phase signal, the last n−1 rows of data in a data column key_01ᵢ may be extracted, where n is a length of the data column key_01ᵢ. A difference between the last n−1 rows of data and the previous row of data is obtained to generate a data difference column key_diffᵢ of two adjacent time points, and a data column indexᵢ of the last n−1 rows of data index values relative to the data column key_01ᵢ corresponding to a difference of 1 is screened out from key_diffᵢ.

Optionally, when second data corresponding to the plurality of predetermined cycles is obtained according to the target index value and the first data, a difference data column index_diffᵢ between two adjacent index values may be obtained from indexᵢ, and a value greater than a statistical indicator is zero in index_diffᵢ. The statistical indicator includes a quarter quantile, an average value, a three-quarter quantile, a mode, and a median. An index value in indexᵢ corresponding to a value of zero in index_diffᵢ is obtained to form anew index column index_0ᵢ. To be specific, an index value in index_0ᵢ is a rising point of the first key-phase signal after a toothed disk is incomplete, and corresponding data between two incomplete rising points is rotation of a crankshaft for a full cycle. Full-cycle data truncation is performed on the first data according to the index value in index_0ᵢ, to obtain the second data corresponding to the plurality of predetermined cycles.

It should be noted that a full-cycle tag may be obtained for the first data according to the target key-phase signal, and consecutive time-domain data, i.e. the first data is split by rotation of the crankshaft for a full cycle according to the full-cycle tag, to obtain the second data corresponding to the plurality of predetermined cycles.

It should be further noted that the first data includes data of a plurality of consecutive predetermined cycles, the second data is a plurality of data obtained after the data of the plurality of consecutive predetermined cycles is divided according to cycles, and each of the second data is data within a predetermined cycle. The reciprocating device runs cyclically, and each of the plurality of predetermined cycles includes: a compression stage, a discharge stage, an expansion stage, and a suction stage.

Optionally, according to second data corresponding to a target cycle, the target data of the reciprocating device corresponding to the target strain association indicator within the target stage in the current working status is obtained. To be specific, a cycle is selected from the plurality of predetermined cycles as the target cycle, and data corresponding to the target cycle in the second data is obtained as the target data.

As an optional embodiment, the step of obtaining predetermined data of the reciprocating device corresponding to the target strain association indicator within the target stage in a predetermined working status includes: determining a target working condition of the reciprocating device in the current working status, and obtaining a target matrix of the reciprocating device corresponding to the target strain association indicator in the predetermined working status, where the target matrix includes data corresponding to a plurality of running working conditions; and obtaining, from the target matrix, predetermined data of the reciprocating device corresponding to the target strain association indicator within the target stage in the predetermined working status, where the predetermined data is data corresponding to the target working condition in the target matrix.

In this embodiment, a plurality of running working conditions may be implemented by combining and setting different working condition parameter values. Types of the working condition parameter values include a device suction pressure, a discharge pressure, a power end motor speed, an engine speed, a discharge flow rate, an in-cylinder medium type, and in-cylinder medium viscosity. Different working condition type sets working_con=(con₁, con₂, con₃, . . . , conᵢ) may be generated according to previous experience and an actual working condition on a simulation site, where con; represents an i^{th} running working condition. In this working condition, values and combinations of the foregoing working condition parameters are different from those of other working conditions, and the same mode is adopted for the other working conditions. Therefore, in various running working conditions, a form of the target matrix may be strain_dataᵢ=[timeᵢ, passᵢ₁, passᵢ₂, . . . , passᵢₖ], where passᵢₖ represents data of the reciprocating pull rod corresponding to the k^{th} cylinder in the predetermined working status, corresponding to the target strain association indicator within the target stage. After the target matrix is determined, predetermined data of the reciprocating device corresponding to the target strain association indicator within the target stage in the predetermined working status may be quickly obtained from the target matrix.

As an optional embodiment, the step of obtaining a target matrix of the reciprocating device corresponding to the target strain association indicator in the predetermined working status includes: obtaining, for the reciprocating device in the predetermined working status, a plurality of second key-phase data corresponding to a plurality of working conditions and a plurality of third data corresponding to the target strain association indicator, where the plurality of third data are data corresponding to the plurality of working conditions, and the plurality of working conditions are in a one-to-one correspondence with the plurality of second key-phase data; preprocessing the plurality of third data, to obtain a plurality of fourth data, and preprocessing the plurality of second key-phase data, to obtain a plurality of predetermined key-phase data; determining a plurality of predetermined index values according to the plurality of predetermined key-phase data; obtaining, according to the plurality of predetermined index values and the plurality of fourth data, a plurality of fifth data corresponding to a target cycle, where the target cycle includes: a compression stage, a discharge stage, an expansion stage, and a suction stage, where the plurality of fifth data are in a one-to-one correspondence with the plurality of working conditions; and determining the target matrix according to the plurality of fifth data.

In this embodiment, a mode of obtaining, for the reciprocating device in the predetermined working status, each of the plurality of second key-phase data corresponding to the plurality of working conditions and each of the plurality of third data corresponding to the target strain association indicator is similar to the foregoing mode of obtaining the first key-phase data and the initial data. The plurality of second key-phase data and the third data in the plurality of different working conditions are obtained to obtain, for the reciprocating device in the predetermined working status, the plurality of second key-phase data corresponding to the plurality of working conditions and the plurality of third data corresponding to the target strain association indicator. A mode of preprocessing the plurality of third data to obtain a plurality of fourth data is similar to the foregoing mode of preprocessing the initial data to obtain first data. A representation form of the plurality of fourth data may be strain_data′ᵢ=[time′ᵢ, pass′ᵢ₁, pass′ᵢ₂, . . . , pass′ᵢₖ]. A mode of preprocessing the plurality of second key-phase data to obtain a plurality of predetermined key-phase data is similar to the foregoing mode of preprocessing the first key-phase data to obtain a target key-phase signal. A mode of determining a plurality of predetermined index values according to the plurality of predetermined key-phase data is similar to the foregoing mode of determining a target index value according to the target key-phase signal. A mode of obtaining, according to the plurality of predetermined index values and the plurality of fourth data, a plurality of fifth data corresponding to the target cycle is similar to the foregoing mode of obtaining, according to the target index value and the first data, second data corresponding to the plurality of predetermined cycles. The plurality of fifth data may be represented as {strain_data′ᵢ₁, strain_data′ᵢ₂, . . . strain_data′ᵢⱼ}, where strain_data′ᵢⱼ represents fifth data of a j^{th} predetermined cycle. The target matrix may be determined according to the plurality of fifth data in a plurality of modes. For example, a single working condition E-T reference vector corresponding to the target strain association indicator may be first constructed, where E is data corresponding to the target strain association indicator, T is time of obtaining the data corresponding to the target strain association indicator, and E is capitalization of s. Under the working condition i, in the plurality of fifth data {strain_data′ᵢ₁, strain_data′ᵢ₂, . . . strain_data′ᵢⱼ}, the k^{th} cylinder is used as an example, i.e. [pass′ᵢₖ₁, pass′ᵢₖ₂, . . . pass′ᵢₖⱼ], where pass′ᵢₖⱼ represents data of the k^{th} cylinder corresponding to the target strain association indicator within the j^{th} predetermined cycle in the i^{th} working condition. [pass′ᵢₖ₁, pass′ᵢₖ₂, . . . pass′ᵢₖⱼ] is expanded to obtain:

$$⌊ {pass}_{ik 1}^{′} , {pass}_{ik 2}^{′} , … {pass}_{ikj}^{′} ⌋ = ( \begin{matrix}str\_ {1}_{0} & str\_ {2}_{0} & … & {str\_j}_{0} \\ str\_ {1}_{1} & str\_ {2}_{1} & … & {str\_j}_{1} \\ … & … & … & … \\ str\_ {1}_{m} & str\_ {2}_{m} & … & {str\_j}_{m}\end{matrix} ) ,$$

where each column in the matrix corresponds to data pass′ᵢₖⱼ corresponding to the target strain association indicator within a predetermined cycle, and str_jₘ represents m^{th} data of the k^{th} cylinder corresponding to the target strain association indicator within the j^{th} predetermined cycle in the i^{th} working condition. A statistical indicator of each column in the matrix is computed according to a row dimension. The statistical indicator includes a maximum value, a minimum value, a median, an average value, a quarter quantile, and a three-quarter quantile, to obtain an E-T reference vector of each cylinder in a single working condition i:

$${pass}_{ik}^{s} = ( {str}_{0 sta} , {str}_{1 sta} , … , {str}_{msta} ) .$$

An E-T reference matrix (equivalent to the foregoing target matrix) of the k^{th} cylinder in the various working conditions may be obtained by computing the E-T reference vector of the k^{th} cylinder in the various working conditions. The E-T reference matrix is as follows:

$$basic\_space = ⌊ {pass}_{1 k}^{s} , {pass}_{2 k}^{s} , … {pass}_{ik}^{s} ⌋ .$$

A target matrix of another cylinder is computed in the same mode. In this mode, the target matrix may be quickly and accurately determined.

As an optional embodiment, the step of determining a target deviation value according to the target data and the predetermined data includes: determining, in a case that the target stage comprises the compression stage, the target deviation value according to the target data, the predetermined data, and a target formula, where the target deviation value represents a degree of phase separation between the target data and the predetermined data.

In this embodiment, in a case that the target stage includes the compression stage, the degree of phase separation represents a time-domain phase translation amount of data obtained by comparing to-be-tested data in a single cycle with an E-T reference vector in a corresponding working condition in an E-T reference matrix basic_space. The target formula is as follows:

$$SEPy\_phase = \frac{{\sum }_{p = m 1}^{m 2} ( s t {r}_{p ‐ sta} - {str\_test}_{p ‐ sta} )}{m} ,$$

where SEPy_phase represents the degree of phase separation, strₚ₋ₛₜₐ represents a p^{th} value of an E-T reference vector pass^{s}ᵢₖ of the k^{th} cylinder in the E-T reference matrix basic_space in the i^{th} working condition, pϵ[m1, m2], 1<m1, m2<m, the data range [m1, m2] corresponds to time of obtaining predetermined data, and str_testₚ₋ₛₜₐ represents a p^{th} value of target data of the k^{th} cylinder in the i^{th} working condition. The degree of phase separation represents a degree of time-domain phase separation between the target data and the predetermined data on a y-axis dependent variable separation in a coordinate system. In this mode, an accurate target deviation value may be quickly determined in a case that the target stage includes the compression stage.

It should be noted that a negative degree of phase separation represents a left curve shift, and a positive degree of phase separation represents a right curve shift.

As an optional embodiment, the step of determining a target deviation value according to the target data and the predetermined data includes: obtaining, in a case that the target stage includes the expansion stage, device running data of the reciprocating device in the current working status; determining a first index value corresponding to the target data and a second index value corresponding to the predetermined data; and determining the target deviation value according to the first index value, the second index value, and the device running data, where the target deviation value represents a degree of phase angle separation between the target data and the predetermined data.

In this embodiment, in a case that the target stage includes the expansion stage, the degree of phase angle separation represents an angle-domain phase angle change amount of data obtained by comparing to-be-tested data in a single cycle with the E-T reference vector in the corresponding working condition in the E-T reference matrix basic_space. The target deviation value may be determined in the following mode:

$$SEPx\_phase = \frac{- {\sum }_{p = m 1}^{m 2} ( ( s t {r}_{p ‐ sta} ) \cdot index - ( {str\_test}_{p ‐ sta} ) \cdot index )}{m} , JD\_number = \frac{60 * srr * FS}{speed * 360} , SEPx\_phase \_angle = \frac{SEPx\_phase}{JD\_number} ,$$

where (strₚ₋ₛₜₐ)·index represents an index value corresponding to the p^{th} value of the E-T reference vector pass^{s}ᵢₖ of the k^{th} cylinder in the E-T reference matrix basic_space in the i^{t}h working condition, and (str_testₚ₋ₛₜₐ)·index represents an index value of the p^{th} value of the target data of the k^{t}h cylinder in the i^{th} working condition. The device running data includes srr, FS, and speed, where srr represents a reduction ratio from a driving end to a crankshaft end, FS represents an original data acquisition frequency, speed represents the speed of the driving end, SEPx_phase represents the degree of time-domain phase separation of an index value corresponding to a strain strong association indicator value, and SEPx_phase_angle represents the degree of angle-domain phase angle separation of the index value corresponding to the strain strong association indicator value. The degree of phase angle separation represents a degree of angle-domain phase angle separation between the target data and the predetermined data on an x-axis independent variable separation in the coordinate system.

As an optional embodiment, after obtaining, according to the target deviation comparison result and a target comparison relationship, a target fault determining result indicating whether the reciprocating device is faulty, the method further includes: transmitting, in a case that the target fault determining result is that the reciprocating device is faulty in the current working status, alarm information to a predetermined terminal.

In this embodiment, in a case that the target fault determining result is that the reciprocating device is faulty in the current working status, alarm information is transmitted to a predetermined terminal, to ensure that the predetermined terminal learns in time information that the reciprocating device is faulty, thereby handling the fault of the reciprocating device in time, and avoiding losses caused by incapability of working of the reciprocating device due to the fault.

Based on the foregoing embodiments and optional embodiments, an optional implementation is provided, which is described below in detail.

An optional implementation of the present disclosure provides a fault determining method of a reciprocating pump, which can determine a fault of a pump valve in the reciprocating pump.

FIG. 8 is an example flowchart of a method according to an optional implementation of the present disclosure. As shown in FIG. 8, a procedure of the method provided in this application is as follows:
S1: Obtain normal-status strain data and key-phase data of a device (equivalent to the foregoing step of obtaining a plurality of second key-phase data corresponding to a plurality of working conditions and a plurality of third data corresponding to a target strain association indicator), and obtain to-be-tested strain data and key-phase data in a working condition (equivalent to the foregoing step of obtaining first key-phase data of a reciprocating pump in a current working status and initial data corresponding to the target strain association indicator).
S2: Obtain or compute a left strain strong association indicator, and obtain or compute a right strain strong association indicator.

It should be noted that when the target strain association indicator includes a strain, a micro-strain, a stress, a pressure, and a pressure intensity, data corresponding to another target strain association indicator may be computed by using the following formula:

$$Pressure intensity = \vert stress \vert \times α . Stress = strain \times elasticity modulus . 1 Strain = {10}^{6} micro ‐ strain .$$

For example, when the target strain association indicator is a stress and data corresponding to the target strain association indicator is a, the target strain association indicator may be converted into a pressure intensity, and by using the formula:

$$Pressure intensity = \vert stress \vert \times α .$$

Data b corresponding to the target strain association indicator is obtained through computation.
S3: Filter the left strain strong association indicator (equivalent to the foregoing step of preprocessing a plurality of third data to obtain a plurality of fourth data), and filter the right strain strong association indicator (equivalent to the foregoing step of preprocessing initial data to obtain first data).
S4: Create standard signal data of a left key-phase signal (equivalent to the foregoing step of preprocessing a plurality of second key-phase data to obtain a plurality of predetermined key-phase data), and create standard signal data of a right key-phase signal (equivalent to the foregoing step of preprocessing first key-phase data to obtain a target key-phase signal).
S5: Obtain a positive cycle tag of the left key-phase signal (equivalent to the foregoing step of determining a plurality of predetermined index values according to a plurality of predetermined key-phase data), and obtain a positive cycle tag of the right key-phase signal (equivalent to the foregoing step of determining a target index value according to a target key-phase signal).
S6: Split positive cycle data of the left strain strong association indicator (equivalent to the foregoing step of obtaining, according to a plurality of predetermined index values and a plurality of fourth data, a plurality of fifth data corresponding to a target cycle), and split positive cycle data of the right strain strong association indicator (equivalent to the foregoing step of obtaining, according to a target index value and first data, second data corresponding to a plurality of predetermined cycles).
S7: Construct a single working condition reference vector of a strain strong association indicator (equivalent to the foregoing step of constructing a single working condition E-T reference vector corresponding to a target strain association indicator).
S8: Select a same working condition reference matrix according to a to-be-tested data working condition (equivalent to the foregoing step of obtaining a target matrix of a reciprocating pump corresponding to a target strain association indicator in a predetermined working status).
S9: Compute a degree of reference phase separation (equivalent to the foregoing step of determining a target deviation value according to target data and predetermined data).
S10: Obtain a rule tree model according to the degree of reference phase separation (equivalent to a rule tree model below).
S11: Obtain a fault diagnosis result of a pump valve (equivalent to the foregoing step of obtaining, according to a target deviation comparison result and a target comparison relationship, a target fault determining result indicating whether a reciprocating pump is faulty).

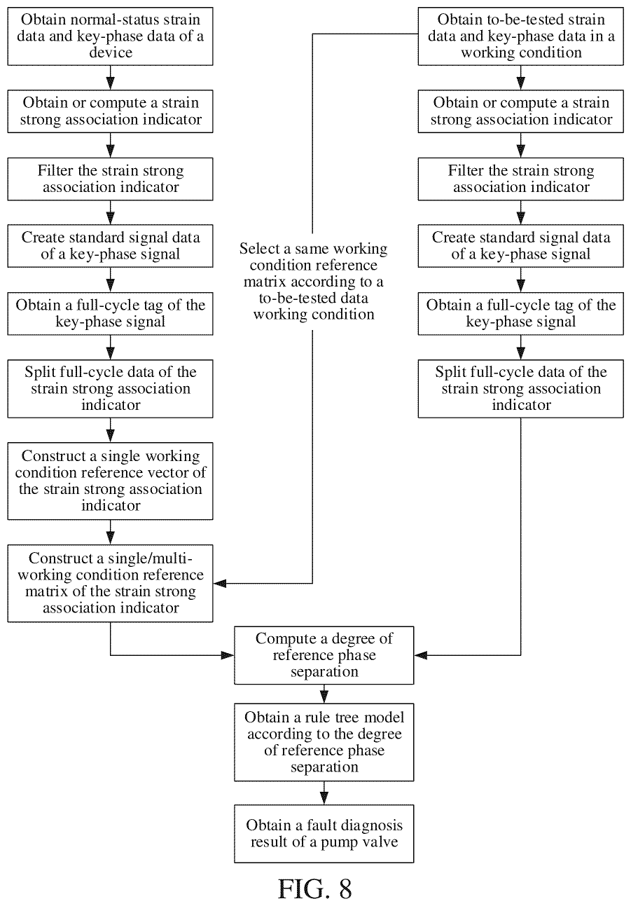

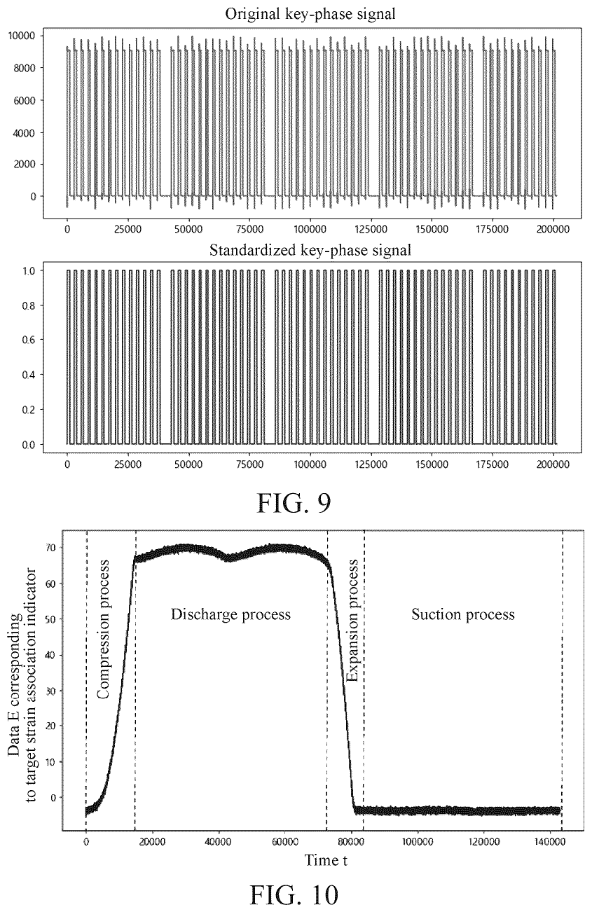

FIG. 9 is an example schematic diagram of preprocessing a key-phase signal according to an optional implementation of the present disclosure. As shown in FIG. 9, after an original key-phase signal is preprocessed, an obtained standardized key-phase signal is less affected by an error.

FIG. 10 is an example schematic diagram of a relation curve of a target strain association indicator and time according to an optional implementation of the present disclosure. In FIG. 10, a compression process is equivalent to the foregoing compression stage, a discharge process is equivalent to the foregoing discharge stage, an expansion process is equivalent to the foregoing expansion stage, and a suction process is equivalent to the foregoing suction stage. As shown in FIG. 10, data corresponding to the target strain association indicator within each predetermined cycle regularly fluctuates with time. In the compression stage, the data corresponding to the target strain association indicator suddenly increases from a low amplitude to a high amplitude. In the discharge stage, the data corresponding to the target strain association indicator is relatively stable at a high-amplitude level. In the expansion stage, the data corresponding to the target strain association indicator suddenly decreases from the high amplitude to the low amplitude. In the suction stage, the data corresponding to the target strain association indicator is relatively stable at a low-amplitude level. The data corresponding to the target strain association indicator may reflect an in-cylinder pressure of the reciprocating pump. To be specific, within each predetermined cycle, the in-cylinder pressure of the reciprocating pump cyclically fluctuates, and a fluctuating curve may be similar to the curve in FIG. 10.

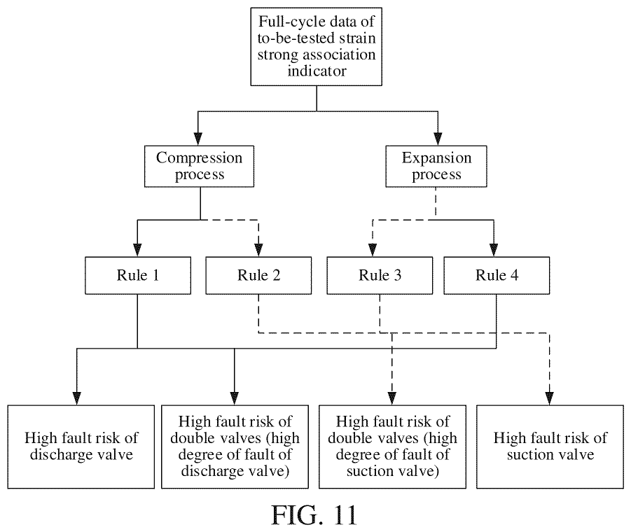

FIG. 11 is an example schematic diagram of a rule tree model according to an optional implementation of the present disclosure. In FIG. 11, positive cycle data of a to-be-tested strain strong association indicator is equivalent to the foregoing target data, a compression process is equivalent to the foregoing compression stage, and an expansion process is equivalent to the foregoing expansion stage. As shown in FIG. 11, to ensure accuracy and effectiveness of the rule tree model, the model may be subdivided and different thresholds are set. To be specific, a rule number model may be constructed for a single cylinder in a single working condition. The rule tree model is constructed by using data of a k^{th} cylinder in an i^{th} working condition as an example, and the same mode is adopted for other cylinders corresponding to other working conditions. Creation dimensions of a tree-like structure of the rule tree model are sequentially as follows from top to bottom: a reciprocating pull rod motion process layer, a fault large-class layer, and a fault small-class layer. A model structure is as follows. A first layer of the tree structure has two branch nodes: an in-cylinder medium compression process and an in-cylinder medium expansion process. A second layer of the tree structure has four branch nodes: rule 1, rule 2, rule 3, and rule 4. A third layer of the tree structure has four branch nodes: a high fault risk of a discharge valve, a high fault risk of a suction valve, a high fault risk of double valves (high degree of fault of the discharge valve), and a high fault risk of double valves (high degree of fault of the suction valve). Based on the foregoing rule tree structure, determining logic of the rule tree model is that: if a target deviation value of the in-cylinder medium compression process triggers rule 1 or a target deviation value of the expansion process triggers rule 4, it is determined that there is a high fault risk of a discharge valve or a high fault risk of double valves (high degree of fault of the discharge valve); and if the target deviation value of the in-cylinder medium compression process triggers rule 2 or the target deviation value of the expansion process triggers rule 3, it is determined that there is a high fault risk of a suction valve or a high fault risk of double valves (high degree of fault of the suction valve).

Table 1 shows rule content of rule 1, rule 2, rule 3, and rule 4, as shown in Table 1:

TABLE 1

| Rule Name | Rule Content |
|---|---|
| Rule 1 | The degree of phase (phase angle) separation is less than or |
| | equal to σ_YL |
| Rule 2 | The degree of phase (phase angle) separation is greater than |
| | or equal to σ_YR |
| Rule 3 | The degree of phase (phase angle) separation is less than or |
| | equal to σ_PL |
| Rule 4 | The degree of phase (phase angle) separation is greater than |
| | or equal to σ_PR |

The degree of phase (phase angle) separation in Table 1 is equivalent to the foregoing target deviation value, and the thresholds σ_YL, σ_YR, σ_PL, and σ_PR in the foregoing table need to be determined through multiple groups of experimental comparison and with reference to previous experience.

It should be noted that based on the foregoing rule tree model, with reference to the degree of time-domain phase separation or the degree of angle-domain phase separation in a motion process in which an in-cylinder medium is acted on, fault diagnosis of an independent pump valve in a multi-cylinder multi-working condition can be implemented, fault location can be implemented based on fault identification, and a specific fault location of the discharge valve or the suction valve can be determined.

By using the foregoing optional implementations, at least the following beneficial effects can be achieved:
(1) A fault of a pump valve in a reciprocating pump may be determined.
(2) An E-T data structure is constructed, data corresponding to a target strain association indicator may correspond to time, and four stages of a predetermined cycle may be distinguished: a compression stage, a discharge stage, an expansion stage, and a suctioning stage, to accurately determine the fault of the pump valve in the reciprocating pump.
(3) When min-max normalization is applied to a preprocessing process of a key-phase signal, the preprocessed key-phase signal is more accurate, and data corresponding to the target strain association indicator may be accurately divided according to the predetermined cycle.
(4) Based on E-T data, an E-dependent variable dimension, a T-independent variable dimension, and a T-independent variable extension angle-domain dimension are respectively constructed, a reference phase separation indicator is constructed based on the three dimensions, and a horizontal translation amount and direction, in the three dimensions, of the data corresponding to the target strain association indicator are evaluated.
(5) A single-working-condition reference E-T vector and a multi-working-condition reference E-T matrix are constructed in consideration of a complex multi-working-condition situation.
(6) A rule tree model is constructed with reference to a target matrix, the compression stage, and the expansion stage, to perform fault identification and fault locating on the reciprocating pump.

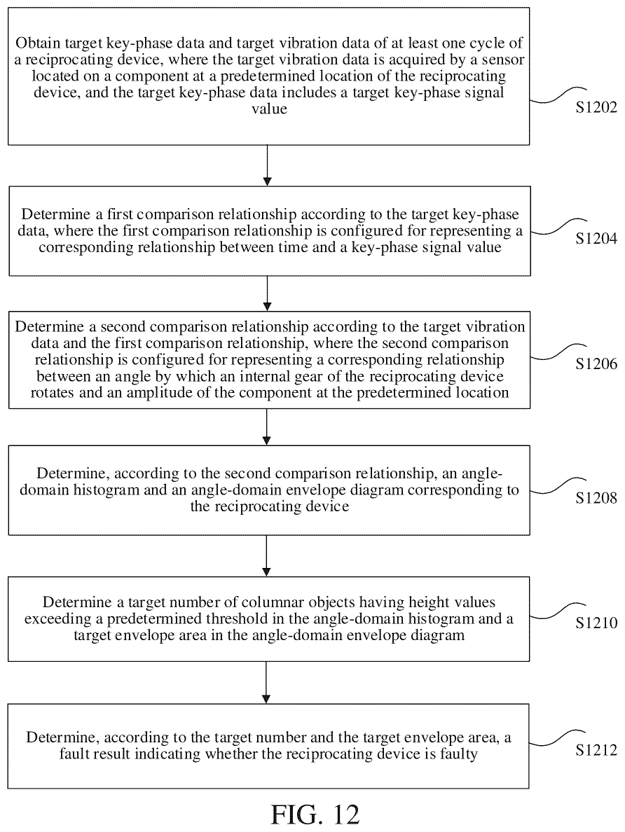

FIG. 12 is an example flowchart of a fault determining method of a reciprocating device according to an embodiment of the present disclosure. As shown in FIG. 12, the method includes the following steps.
Step S1202: Obtain target key-phase data and target vibration data of at least one cycle of a reciprocating device, where the target vibration data is acquired by a sensor located on a component at a predetermined location of the reciprocating device, and the target key-phase data includes a target key-phase signal value.

In step S1202, the target key-phase data and the target vibration data of the reciprocating device within the at least one cycle are determined, to determine, according to data acquired on the reciprocating device, a fault result indicating whether the reciprocating device is faulty. Since the target vibration data is acquired by the sensor located on the component at the predetermined location of the reciprocating device, it may be subsequently determined, according to the target vibration data, whether the component at the predetermined location of the reciprocating device is faulty.
Step S1204: Determine a first comparison relationship according to the target key-phase data, where the first comparison relationship is configured for representing a corresponding relationship between time and a key-phase signal value.

In step S1204, the first comparison relationship for representing the corresponding relationship between the time and the key-phase signal value is determined. The corresponding relationship between the time and the key-phase signal value at different moments in at least one cycle can be simply and clearly learned from the comparison relationship, to quickly analyze and process data subsequently.
Step S1206: Determine a second comparison relationship according to the target vibration data and the first comparison relationship, where the second comparison relationship is configured for representing a corresponding relationship between an angle by which an internal gear of the reciprocating device rotates and an amplitude of the component at the predetermined location.

In step S1206, the second comparison relationship for representing the corresponding relationship between the angle by which the internal gear of the reciprocating device rotates and the amplitude of the component at the predetermined location is determined. The amplitude of the component at the predetermined location when the gear rotates by different angles can be simply and clearly learned from the comparison relationship, and the relationship therebetween can be directly and clearly observed, to facilitate subsequent fault analysis.

The first comparison relationship and the second comparison relationship may be represented in different representation forms. For example, the first comparison relationship and the second comparison relationship may be represented in a graph mode, a table mode, and the like. The representation forms are not limited herein, and may be customized according to an actual application and scenario.
Step S1208: Determine, according to the second comparison relationship, an angle-domain histogram and an angle-domain envelope diagram corresponding to the reciprocating device.

In step S1208, according to the second comparison relationship representing the corresponding relationship between the angle by which the internal gear of the reciprocating device rotates and the amplitude of the component at the predetermined location, the angle-domain histogram and the angle-domain envelope diagram corresponding to the reciprocating device can be obtained, to analyze the fault of the reciprocating device by using the angle-domain histogram and the angle-domain envelope diagram.
Step S1210: Determine a target number of columnar objects having height values exceeding a predetermined threshold in the angle-domain histogram and a target envelope area in the angle-domain envelope diagram.

In step S1210, since the height values of the columnar objects in the angle-domain histogram are easily obtained and obvious, the target number of columnar objects having the height values exceeding the predetermined threshold in the angle-domain histogram may be determined. In addition, the target envelope area in the angle-domain envelope diagram is conveniently obtained through computation. Therefore, the target envelope area in the angle-domain envelope diagram may be determined. By using the target number and the target envelope area, a fault of the reciprocating device can be quickly analyzed, and by using the two types of information, in consideration of two aspects of data, the fault is comprehensively determined, which is beneficial to accuracy of a determined fault result.
Step S1212: Determine, according to the target number and the target envelope area, a fault result indicating whether the reciprocating device is faulty.

By means of the foregoing steps, target key-phase data and target vibration data of at least one cycle of a reciprocating device are obtained, where the target vibration data is acquired by a sensor located on a component at a predetermined location of the reciprocating device, and the target key-phase data includes a target key-phase signal value. A first comparison relationship for representing a corresponding relationship between time and a key-phase signal value is determined according to the target key-phase data, and a second comparison relationship for representing a corresponding relationship between an angle by which an internal gear of the reciprocating device rotates and an amplitude of the component at the predetermined location is determined according to the target vibration data and the first comparison relationship, so that an angle-domain histogram and an angle-domain envelope diagram corresponding to the reciprocating device can be determined according to the second comparison relationship. Further, a target number of columnar objects having height values exceeding a predetermined threshold in the angle-domain histogram and a target envelope area in the angle-domain envelope diagram are determined, to achieve a purpose of determining, according to the target number and the target envelope area, a fault result indicating whether the reciprocating device is faulty. A fault of the reciprocating device is determined directly and accurately by using an image, thereby solving a technical problem that it is unlikely to accurately determine a fault of a reciprocating device in the related art.

As an optional embodiment, the step of determining, according to the second comparison relationship, an angle-domain histogram corresponding to the reciprocating device includes: determining first angle numbers for generating the angle-domain histogram; determining, according to the second comparison relationship, an average amplitude value corresponding to each first angle number within a predetermined angle range; and determining, according to the average amplitude value corresponding to each first angle number within the predetermined angle range, the angle-domain histogram corresponding to the reciprocating device.

In this embodiment, the first angle numbers may be understood as dividing the predetermined angle range into a plurality of angle ranges according to the first angle number, where angles in each of the plurality of angle ranges obtained after division are the first angle numbers. For example, if the first angle number is set to 10 degrees and the predetermined angle range is 0-180 degrees, 0-10 degrees, 10-20 degrees, . . . , 170-180 degrees, and so on are obtained after division. The determining an average amplitude value corresponding to each first angle number within the predetermined angle range refers to: determining an average amplitude value corresponding to 0-10 degrees, determining an average amplitude value corresponding to 10-20 degrees, . . . , determining an average amplitude value corresponding to 170-180 degrees, and so on. According to the average amplitude value corresponding to each first angle number within the predetermined angle range, the angle-domain histogram corresponding to the reciprocating device is determined. For example, if a horizontal coordinate of the angle-domain histogram is an angle and a vertical coordinate is an amplitude, a height value of a columnar object corresponding to 0-10 degrees is the average amplitude value corresponding to 0-10 degrees, and a height value of a columnar object corresponding to 10-20 degrees is the average amplitude value corresponding to 10-20 degrees. The height values of the columnar objects within the entire predetermined angle range are computed, to achieve a purpose of determining the height values of all the columnar objects in the angle-domain histogram.

As an optional embodiment, the step of determining, according to the second comparison relationship, an angle-domain envelope diagram corresponding to the reciprocating device includes: determining second angle numbers for generating the angle-domain envelope diagram; determining, according to the second comparison relationship, a maximum amplitude value and a minimum amplitude value corresponding to each second angle number within a predetermined angle range; and determining, according to the maximum amplitude value and the minimum amplitude value corresponding to each second angle number within the predetermined angle range, the angle-domain envelope diagram corresponding to the reciprocating device.

In this embodiment, the second angle numbers may be understood as dividing the predetermined angle range into a plurality of angle ranges according to the second angle number, where angles in each of the plurality of angle ranges obtained after division are the second angle numbers. For example, if the second angle number is set to 1 degrees and the predetermined angle range is 0-180 degrees, 0-1 degree, 1-2 degrees, . . . , 179-180 degrees, and so on are obtained after division. A maximum amplitude value and a minimum amplitude value corresponding to each second angle number within a predetermined angle range are determined. For example, a maximum amplitude value and a minimum amplitude value corresponding to 0-1 degree are determined, a maximum amplitude value and a minimum amplitude value corresponding to 1-2 degrees are determined, . . . , and a maximum amplitude value and a minimum amplitude value corresponding to 179-180 degrees are determined. The angle-domain envelope diagram corresponding to the reciprocating device is determined according to the maximum amplitude value and the minimum amplitude value corresponding to each second angle number within the predetermined angle range. For example, if the horizontal coordinate of the angle-domain histogram is an angle and the vertical coordinate is an amplitude, an envelope region corresponding to 0-1 degree is a region between the maximum amplitude value corresponding to 0-1 degree and the minimum amplitude value corresponding to 0-1 degree, an area of the region is computed, and an area within the entire predetermined angle range is computed, to achieve a purpose of determining an envelope area in the angle-domain envelope diagram.

As an optional embodiment, the step of determining, according to the maximum amplitude value and the minimum amplitude value corresponding to each second angle number within the predetermined angle range, the angle-domain envelope diagram corresponding to the reciprocating device includes: transforming, according to a Hilbert transform method, the maximum amplitude value and the minimum amplitude value corresponding to each second angle number within the predetermined angle range, to obtain an envelope value corresponding to each second angle number within the predetermined angle range; and determining, according to the envelope value corresponding to each second angle number within the predetermined angle range, the angle-domain envelope diagram corresponding to the reciprocating device.

In this embodiment, a method for converting an amplitude value and an envelope value is described. The amplitude value may be converted into the envelope value according to a Hilbert transform method. Optionally, the amplitude value may further be transformed into the envelope value by using a Hilbert-like transform method, to generate the angle-domain envelope diagram that may accurately reflect the fault status of the reciprocating device.

As an optional embodiment, after determining, according to the target number and the target envelope area, a fault result indicating whether the reciprocating device is faulty, the method further includes: determining, in a case that the target vibration data comprises a plurality of target vibration data acquired by sensors located on components at a plurality of predetermined locations of the reciprocating device and the fault result is that the reciprocating device is faulty, a fault location of the reciprocating device according to the plurality of target vibration data.

In this embodiment, in a case that the target vibration data includes a plurality of target vibration data acquired by sensors located on components at a plurality of predetermined locations of the reciprocating device and the fault result is that the reciprocating device is faulty, a fault location of the reciprocating device may be accurately determined based on the plurality of target vibration data. For example, in a case that one of the plurality of vibration data is faulty, it is determined that a component or a sensor is faulty at a predetermined location corresponding to the faulty vibration data, so that the fault can be determined more precisely.

As an optional embodiment, before the obtaining target key-phase data and target vibration data of at least one cycle of a reciprocating device, the method further includes: obtaining initial key-phase data and initial vibration data of at least one cycle of the reciprocating device; and filtering the initial key-phase data and the initial vibration data, to obtain the target key-phase data and the target vibration data of the at least one cycle of the reciprocating device.

In this embodiment, the initial key-phase data and the initial vibration data directly obtained are filtered, to obtain the target key-phase data and the target vibration data after filtering, thereby reducing noise in the target key-phase data and the target vibration data, and making a subsequently obtained fault result more accurate.

As an optional embodiment, the step of determining, according to the target number and the target envelope area, a fault result indicating whether the reciprocating device is faulty includes: determining, in a case that the target number is greater than a predetermined number and/or the target envelope area is greater than a predetermined envelope area, that the fault result of the reciprocating device is that the reciprocating device is faulty.

In this embodiment, in a case that the target number is greater than a predetermined number, it indicates that the amplitude is abnormal. Similarly, in a case that the target envelope area is greater than a predetermined envelope area, it can also indicate that the amplitude is abnormal. Therefore, by means of this determination, the fault result indicating whether the reciprocating device is faulty can be accurately obtained.

Based on the foregoing embodiments and optional embodiments, an optional implementation is provided, which is described below in detail.

An optional implementation of the present disclosure provides a fault determining method and a fault determining system of a reciprocating pump.

### I. Fault Determining System:

The fault determining system includes: a sensor detection module and a filtering module, where the sensor detection module further includes a key-phase sensor, a vibration sensor, and the like.

### (1) Sensor Detection Module:

A main function is to select a specific detection location according to a detection requirement, design a specific detection assembly, and measure a to-be-processed signal.

### 1) Selection of Measurement Point Location:

A measurement point of a vibration signal needs to be at a location that is sensitive to a vibration response and is as close to a vibration source as possible. A related bracket needs to be designed according to a requirement to fix a sensor.

A measurement point location of a key-phase signal needs to be perpendicular to an axial direction or a radial direction of a crankshaft, and a coded disk is mounted on a mechanism connected to the crankshaft.

FIG. 4 is an example schematic diagram of a location of a vibration sensor according to an optional implementation of this application. FIG. 5 is an example schematic diagram of a location of a key-phase sensor according to an optional implementation of this application. Various vibration signals (a crankshaft bearing measurement point, a cross head measurement point, a disk root measurement point, and the like) and key-phase signal data of a reciprocating pump of a fracturing device are acquired. Since it is inconvenient in a transportation and on-site maintenance process to have a horizontal location of the crankshaft bearing measurement point, the crankshaft bearing measurement point is mounted in a 450 direction of a bearing region. The cross head measurement point is mounted at a main runner bearing location, i.e. a cross head lower sliding rail. The disk root measurement point is mounted in a vertical direction of a disk root cavity, and the vibration sensor is arranged at a location shown in FIG. 4. A mounting measurement point of the key-phase sensor is located in a vertical direction of an axial connection between a crankshaft lubricating oil seal and a crankcase body, and a specific location is shown in FIG. 5.

### 2) Coded Disk Design:

In a process of obtaining the key-phase signal, a coded disk design needs to be performed. The key-phase signal needs to obtain a rotation start location of a measurement axis and a rotation speed of the measurement axis, and needs to provide reference coordinates for a measured vibration phase angle. The following separately explains the three requirements:
(a) For the start location of the measurement axis, a location of a plunger at a moment needs to be preselected as a zero point P₀, and a subsequent angle point is computed based on this. Then, the zero point P₀ is identified in the sensor data according to particularity of a gear spacing and shape particularity of a gear.
(b) For the rotation speed of the measurement axis, time T (unit: second) used for rotation of the same gear on the coded disk for a circle is measured, and the rotation speed of the measurement axis is V=60/T (r/min).
(c) The coded disk needs to provide reference coordinates for a phase angle of a measured vibration signal. Based on this requirement, a key-phase signal is required to provide a signal feature having an angle identifier. To be specific, a gear on the coded disk may need to correspond to a phase of the signal, and the corresponding phases may be equally spaced, or may be unequally spaced. If the gears of the coded disk are equally spaced and there are a total of N keys, a set of angles Pᵢ={p₁, p₂, . . . pᵢ} of a rising edge of each gear may be obtained by computing

$${P}_{i} = {P}_{0} + \frac{360 \times i}{N} .$$

If the gears are unequally spaced, Pᵢ=P₀+Sᵢ may be obtained according to an arrangement location relationship during design.

FIG. 6 is an example schematic diagram of a coded disk according to an optional implementation of this application. A design of a coded disk when a key-phase signal of a reciprocating pump of a fracturing device is measured is shown in FIG. 6. Coded disks M1, M2, and M3 are arranged from left to right. A farthest end of motion of the plunger is used as a zero point P₀, the rising edge triggers, and different angles may be computed by using the location and the distribution of the gears on the coded disk.

As shown in M1, the start location of the measurement axis is identified by changing a gear spacing. A signal zero-angle point P₀ is shown at a black arrow. In addition to that, there are 17 (16 gears+1 missing tooth) gears in total, and an angle Pᵢ={p₁, p₂, . . . pᵢ} of each gear may be computed into

$${P}_{i} = {P}_{0} + \frac{360 \times i}{17} \approx 21.18 \times i ( initial angle {P}_{0} = 0 )$$

by using a formula. An angle of gears of M2 is computed in the same mode as M, but the start location of the measuring axis is identified as a zero point P₀ defined by a triangular rule. Gears of M3 are unequally spaced, and a relative angle of each gear relative to the first gear is known during design and is marked as Sᵢ={106.0°, 190.6°, 254.2°, 296.5°, 317.7° }. Therefore, during measurement, an angle location of each gear is Pᵢ=P₀+Sᵢ=Sᵢ(initial angle P₀=0).

In a later period, an angle between a drainage start moment and a suction start moment of each cylinder of the reciprocating pump relative to a key-phase location is computed according to a location at which the key-phase sensor is mounted and a working sequence of the cylinders of the reciprocating pump.

### (2) Filter Module:

The signal is filtered and preprocessed, to extract main components of the signal. In on-site working conditions, data obtained by measurement is usually noisy, and an acquired signal S_{acquisition}=S_{desired}+S_{powerline-interference}+S_{other-interference} may include a desired signal S_{desired}, and has a particular power line interference S_{powerline-interference} and other interference signals S_{other-interference}.

First, the power line interference S_{powerline-interference} needs to be filtered out by using a hardware method. Then, by designing a digital filter (a low-pass or band-pass filter), interference signals S_{other-interference} in other bands are filtered out as far as possible.

For example, when various vibration signals and key-phase signals of the reciprocating pump of the fracturing device are processed, interference noises in a particular band need to be first filtered out by using filter hardware, and then data is stored. An infinite impulse response high-pass filter Hᵢ={h₁, h₂, . . . hᵢ} is added to a digital signal filter processing part, a sampling frequency is Fs=16384 Hz, the number of orders is 8, a high-pass cut-off frequency is 1000 Hz, and an out-band attenuation is −30 dB@800 MHz. The signal is digitally filtered by using Hᵢ={h₁, h₂, . . . hᵢ}, and a signal of a low-frequency (less than 1000 Hz) part of data is filtered out to obtain data with less noise after filtering, to perform subsequent processing.

### II. Fault Determining Method:

The fault determining method includes an angle-domain signal processing display module and a fault threshold monitoring module. The angle-domain signal processing display module includes a key-phase signal diagram, an angle-domain vibration diagram, an angle-domain histogram, and an angle-domain envelope diagram. The fault threshold detection module includes three parts: empirical threshold generation, threshold determining, and fault locating.

### (1) Angle-Domain Signal Processing Display Module:

The angle-domain signal processing display module mainly includes construction of the key-phase signal diagram, the angle-domain vibration diagram, the angle-domain histogram, and the angle-domain envelope diagram.

### (1) Key-Phase Signal Diagram:

Key-phase data X_{keyphasor}={xₚ₁, xₚ₂, . . . xₚᵢ} to be analyzed within N cycles is taken. A signal key-phase signal diagram is made by using time as a horizontal coordinate (equivalent to the foregoing first comparison relationship presented in a form of a diagram).

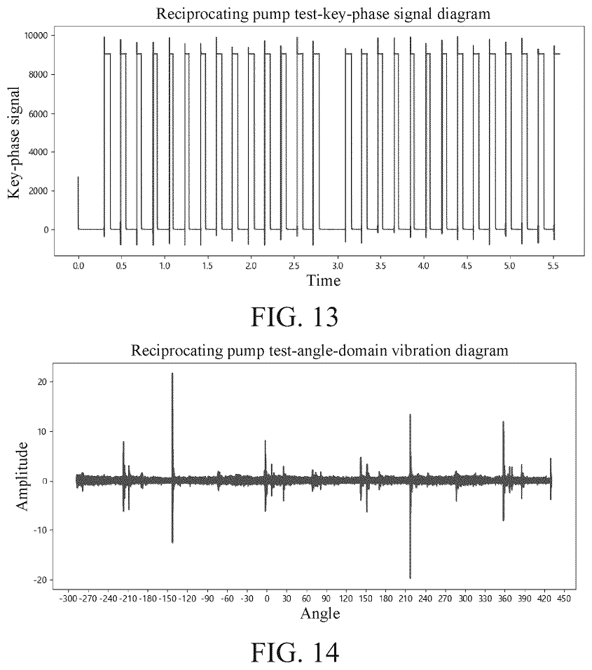

FIG. 13 is an example reciprocating pump test-key-phase signal diagram according to an optional implementation of this application. A key-phase signal is made by using key-phase data of a reciprocating pump, and data made within two cycles is shown in FIG. 13.

It should be noted that each cycle of key-phase data is T=360°. If the number of teeth of the coded disk is N, an angle value Ang_{numberofteeth}={aₜ₁, aₜ₂, . . . aₜᵢ} corresponding to a rising edge (or a falling edge) of each gear C_{number}={c₁, c₂, . . . c_{N}} may be computed by using the formula

$$Ang = \frac{T \times i}{N} ,$$

and may be used as a reference for subsequent fault diagnosis and analysis of another angle-domain diagram. Note: i is a sequence number of a gear.

### 2) Angle-Domain Vibration Diagram:

A relationship between vibration signal data of N cycles within time [t1, t2] corresponding to the key-phase signal and vibration data Amp-Time is taken, and an angle-amplitude relationship Phase—Amp within the N cycles is obtained according to the relationship between the key-phase data Phase—Time (which may be the foregoing key-phase signal diagram). By using an angle as a horizontal coordinate and an amplitude as a vertical coordinate, an angle-domain vibration diagram of the signal is obtained (equivalent to the foregoing second comparison relationship presented in a form of a diagram).

A concept of “negative angle” is introduced to displaying of the angle-domain vibration diagram, to facilitate observing a motion situation of a cylinder sequence in a motion cycle. A horizontal coordinate of the angle-domain vibration diagram is an angle, and a vertical coordinate is an amplitude of data. A start moment of a motion cycle to be observed by each cylinder is set to a zero-angle moment, and an angle “0°” is set on the angle-domain vibration diagram. An angle before a motion cycle to be observed is a “negative angle”, and an angle value after the cylinder starts to work is a positive angle.

It is assumed that the reciprocating pump has J cylinders in total and a signal processing cycle is N, a relationship between an angle range of a display signal in the angle-domain vibration diagram and a cylinder sequence is shown in the following formula:

$$Angle = \{ \begin{matrix}0 ° ∼ 360 \times N ° & cylinder sequence 1 \\ - \frac{360 °}{J} ∼ 360 \times N ° - \frac{360 °}{J} & cylinder sequence 1 \\ - \frac{360 °}{J} \times ( i - 1 ) ∼ 360 \times N ° - \frac{360 °}{J} \times ( i - 1 ) & cylinder sequence i , i \leq J\end{matrix} .$$

FIG. 14 is an example reciprocating pump test-angle-domain vibration diagram according to an optional implementation of this application. Angle-domain vibration data of data made within two cycles is shown in FIG. 14.

### 3) Angle-Domain Histogram:

The angle-domain histogram is drawn by averaging data of the angle-domain vibration diagram every specified degree X as one piece of data.

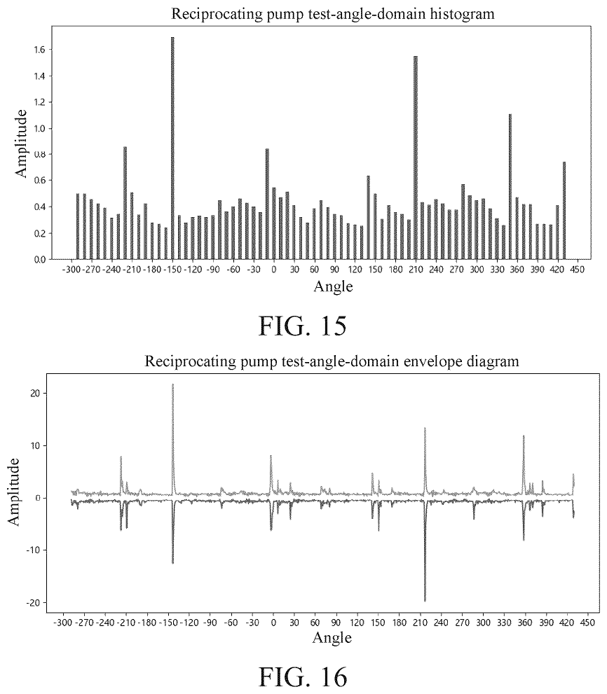

FIG. 15 is an example reciprocating pump test-angle-domain histogram according to an optional implementation of the present disclosure. Data within two cycles is made. First, angle-domain data (which may be the foregoing angle-domain vibration diagram) within two entire cycles is obtained, and an x-axis of the histogram, i.e. the numbers of positive and negative angle items included in the histogram, is computed according to a cylinder sequence. Then, division is performed from 0 degree to a positive angle and a negative angle according to a division principle (for example, division is performed into one piece of data at 10°). Since a scale on a leftmost side or a rightmost side of the angle-domain vibration diagram may not be an integer multiple of 10, it needs to be determined whether boundary data is achieved in a division process. If a boundary is reached, the boundary data is drawn as one piece of histogram data from a division start point to the boundary. Therefore, an angle-domain histogram within two entire cycles shown in FIG. 15 may be obtained.

### 4) Angle-Domain Envelope Diagram:

According to the angle-domain vibration data (which may be the foregoing angle-domain vibration diagram), data is further processed, to obtain an angle-domain envelope diagram. The shape and envelope area of the angle-domain envelope diagram may be used as an important basis for determining whether the reciprocating pump works normally.

It should be noted that in a process of converting the amplitude value and the envelope value, Hilbert transform may be used, to obtain the angle-domain envelope diagram.

Steps of the method for determining the envelope area may be as follows, using data within two cycles as an example:
S1: Obtain data of an angle-domain vibration diagram within two cycles.
S2: Obtain a maximum value and a minimum value of the data within the two cycles every 1°.
S3: Compute, according to a cylinder sequence, an angle range that needs to be displayed, which may be obtained according to a relationship between an angle range in which a signal is displayed and the cylinder sequence in the angle-domain vibration diagram.
S4: Perform equivalent Hilbert transform by using fast Fourier transform (FFT) and inverse fast Fourier transform (IFFT), to obtain an envelope value of the data.
S4.1: Perform N-point FFT on the data (the maximum value and the minimum value obtained in step 2), to obtain data Y(n).
S4.2: Process the data Y(n), multiply first n/2 point data Y(n) by 2, and assign 0 to last n/2 point data Y(n).
S4.3: Perform IFFT on the processed data, to obtain a complex number x(k).
S4.4: Finally, perform a modulo operation on the complex number x(k), to obtain envelope data after the Hilbert transform.
S5: Perform drawing by using the computed angle range and the envelope data to obtain an angle-domain envelope diagram.
S6: Obtain an envelope area.

FIG. 16 is an example reciprocating pump test-angle-domain envelope diagram according to an optional implementation of the present disclosure. A data angle-domain envelope within two cycles is shown in FIG. 16.

### (2) Fault Threshold Monitoring Module:

When it is determined whether the reciprocating pump has a fault, determining may be performed according to the number of columnar objects having height values exceeding a specified threshold in the angle-domain histogram and a main envelope area in the envelope diagram.

For the height value of the columnar object, a fault detection threshold, i.e. a height threshold of the histogram, is generated according to angle-domain histogram data during normal working of the reciprocating pump. The number of columnar objects exceeding the specified height is computed. If the number is within a normal range, it indicates that the cylinder is working normally. Otherwise, it is determined that there is a fault.

For the main envelope area, a fault detection threshold, i.e. a main envelope area threshold, is generated according to the angle-domain envelope diagram data during normal working of each cylinder. Then, threshold determining is performed on the envelope area of the reciprocating pump in a test status. If the envelope area is within a normal range, the cylinder works normally. Otherwise, it is determined that the reciprocating pump has a fault.

When a fault alarm occurs in the threshold detection data, a fault location and a fault condition need to be analyzed according to the angle-domain vibration diagram and a working mode of the reciprocating device.

For example, the effectiveness of an angle-domain signal processing-based reciprocating pump fault diagnosis method is verified.

The effectiveness of the angle-domain signal processing-based reciprocating pump fault diagnosis method is verified. Taking a normal key-phase signal and vibration signal acquired during the test of the reciprocating pump, and a key-phase signal and vibration signal measured under the condition of a leakage fault of the reciprocating pump as examples, effectiveness verification for fault detection of the angle-domain histogram and effectiveness verification for fault detection of the angle-domain envelope diagram are set respectively.

A platform reciprocating device is tested. Test data includes vibration data AI1-01 (1-cylinder), AI1-02 (2-cylinder), AI1-03 (3-cylinder), AI1-04 (4-cylinder), AI1-05 (5-cylinder), vibration data AI1-06 of a cylinder cross head (far end of a reduction gearbox), key-phase data AI1-14, a suction pressure AI1-17, and a discharge pressure AI1-18 of five cylinders in a normal working status.

Test data further includes vibration data AI2-01 (1-cylinder), AI2-02 (2-cylinder), AI2-03 (3-cylinder), AI2-04 (4-cylinder), AI2-05 (5-cylinder), vibration data AI2-06 of a cylinder cross head (far end of a reduction gearbox), key-phase data AI2-14, a suction pressure AI2-17, and a discharge pressure AI2-18 of five cylinders in a pump valve leakage status. Cylinder sequences of five plunger pumps are 1-3-5-2-4, and a signal is sampled and filtered at 51200 Hz and then transferred to a computer for storage.

The number of gears of a key-phase coded disk is 15 (including one missing tooth), and the foregoing plurality of images are constructed according to the angle-domain signal processing display method by using a falling edge effective triggering mode.

FIG. 14 to FIG. 16 may be considered as angle-domain diagrams of a reciprocating pump having a cylinder sequence of 1 in a normal status.

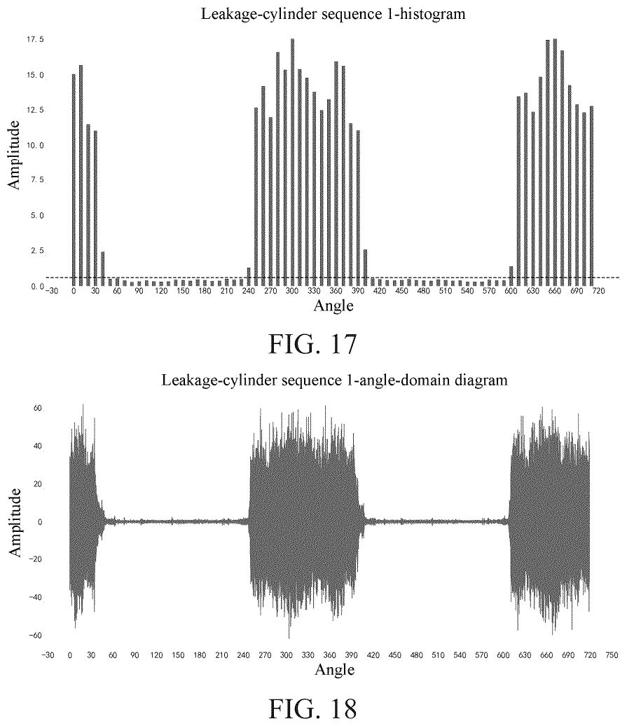

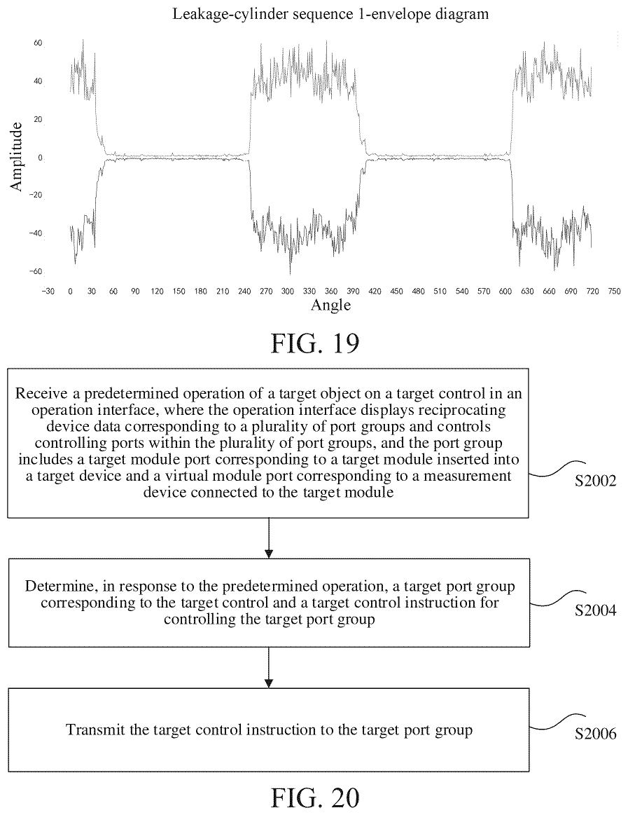

FIG. 17 is an example reciprocating device test-angle-domain vibration diagram in a fault case according to an optional implementation of this application. FIG. 18 is an example reciprocating device test-angle-domain histogram in a fault case according to an optional implementation of this application. FIG. 19 is an example reciprocating device test-angle-domain envelope diagram in a fault case according to an optional implementation of the present disclosure. FIG. 17 to FIG. 19 are angle-domain diagrams of a reciprocating pump having a cylinder sequence of 1 in a faulty status.

For example, it is assumed that the fault problem is a problem of pump valve leakage. According to normal histogram data, a histogram height threshold L is generated, and then the number of columnar objects greater than the threshold L in the histogram is determined as a range of a normal value. Then, data of a real columnar object greater than L in a test process is calculated and compared. It can be observed that if 0.6 is used as the threshold L, a value of a normal cylinder is 7. A value of pump valve leakage is 34. There is a clear difference between the two values, so that it may be determined that the cylinder has a leakage problem.

It may further be determined, according to the area of the angle-domain envelope diagram, whether a pump valve is leaked. For example, an envelope area of a normal tested cylinder is 1366, and the area of the envelope diagram after the leakage is 25170. There is a clear difference therebetween.

A columnar eigenvalue of another cylinder is compared with a value of an envelope eigenvalue column. Table 2 is a table of comparing eigenvalues of a normal cylinder and a leaking cylinder. As shown in Table 2, it can be seen that by using this method, whether a leakage or another problem occurs may be clearly determined, so as to determine a fault as soon as possible, to repair the reciprocating pump.

TABLE 2

| | Normal | Leakage Value | Normal Value | Leakage Value |
|---|---|---|---|---|
| No. | L | L | S | S |
| Cylinder | 7 | 34 | 1366 | 25170 |
| Sequence 1 | | | | |
| Cylinder | 12 | 35 | 1792 | 26944 |
| Sequence 2 | | | | |
| Cylinder | 13 | 38 | 1641 | 11889 |
| Sequence 3 | | | | |
| Cylinder | 9 | 38 | 1360 | 79344 |
| Sequence 4 | | | | |
| Cylinder | 7 | 35 | 1381 | 25170 |
| Sequence 5 | | | | |

By using the foregoing optional implementations, at least the following beneficial effects can be achieved:
(1) During angle-domain vibration data display, a “negative angle” is introduced into other cylinders than the cylinder having a cylinder sequence of 1. To be specific, before a cylinder starts to work in a zero phase, a segment of data is introduced for display, to compare statuses of the cylinder before and after working. It is ensured that key-phase data and displayed vibration data of different cylinders are all at the same moment, which is beneficial to comparing working statuses of all the cylinders.
(2) Angle-domain histogram data is introduced to display scattered vibration data more briefly and intuitively, which is beneficial to simplifying workload of subsequent threshold determining and improving accuracy and convenience of threshold detection.
(3) Angle-domain envelope diagram data is introduced, so that a data display image has a high similarity with vibration data, and another determining mode is provided for fault detection, thereby improving determining accuracy.
(4) A complex vibration data diagnosis process is abstracted into several simple numerical quantities, and presentation result data is simple and highly efficient.
(5) The method has strong applicability and is applicable to fault diagnosis of the reciprocating device.

FIG. 20 is an example flowchart of a port control method according to an embodiment of the present disclosure. As shown in FIG. 20, the method includes the following steps.
Step S2002: Receive a predetermined operation of a target object on a target control in an operation interface, where the operation interface displays reciprocating device data corresponding to a plurality of port groups and controls controlling ports within the plurality of port groups, and the port group includes a target module port corresponding to a target module inserted into a target device and a virtual module port corresponding to a measurement device connected to the target module.

In step S2002, a target object performs an operation in an operation interface. The operation interface displays data of a reciprocating device corresponding to a plurality of port groups, such as vibration data corresponding to a vibration sensor mounted on a reduction gearbox of the reciprocating device or vibration data corresponding to a vibration sensor mounted on a crankcase of the reciprocating device. A life status of the reciprocating device and a fault situation of the reciprocating device can be known according to the vibration data, a running situation and a working cycle of the reciprocating device may alternatively be known, or historical data corresponding to any port group may be selected for viewing an abnormal case and predicting a life cycle. In this application, different data corresponds to different port groups. To be specific, different port groups correspond to different data corresponding to different locations of the reciprocating device. By using the port groups, data correspondingly acquired by the port groups can be directly displayed on an interface, or modules related to this type of data can be directly controlled by controlling the port groups. To be specific, the port groups include target module ports corresponding to target modules inserted into target devices and virtual module ports corresponding to measurement devices connected to the target modules.
Step S2004: Determine, in response to the predetermined operation, a target port group corresponding to the target control and a target control instruction for controlling the target port group.

In step S2004, the predetermined operation may be an operation such as a click, and the predetermined operation may correspond to different types of control. Therefore, a target port group corresponding to the target control and a target control instruction for controlling the target port group are determined by using the predetermined operation, to control ports in the target port group.
Step S2006: Transmit the target control instruction to the target port group.

By means of the foregoing steps, a predetermined operation performed by a target object on a target control in an operation interface is received, a target port group corresponding to the target control and a target control instruction for controlling the target port group are determined in response to the predetermined operation, and the target control instruction is transmitted to the target port group, to control target ports in the target port group. Since the target object performs an operation on the operation interface and the operation interface displays data of a reciprocating device corresponding to a plurality of port groups and controls respectively controlling ports in the plurality of port groups, all data can be clearly seen, and the ports can be controlled in time according to a status of the data. In addition, the port group includes a target module port corresponding to a target module inserted into a target device, and a virtual module port corresponding to a measurement device connected to the target module. Therefore, port control is also objective and specific. The target port group is arranged, and the ports in the target port group can be quickly controlled in response to the predetermined operation, to accurately control the ports, thereby solving a technical problem of control disorder when a port related to a reciprocating device is controlled in the related art.

As an optional embodiment, before receiving a predetermined operation of a target object on a target control in an operation interface, the method further includes: transmitting a use request to a target server, where the use request carries a target device parameter of the target device; receiving, in a case that the target device parameter is consistent with a predetermined device parameter, a use permission instruction transmitted by the target server; and displaying, in response to the use permission instruction, the operation interface corresponding to the target application.

In this optional embodiment, a use permission instruction of a target server is obtained, which is equivalent to that a process of verifying a target device used by a target object is disclosed. To be specific, when the target object uses the target device to control a port, verification needs to succeed first, to verify whether the target device has a permission to control the port.

For example, verification may be performed in the following mode using a use certificate:

First, it should be noted that before verification is performed by using a use certificate, the use certificate needs to be created first. The creation process is first described by using an example.
S1: Obtain a predetermined device parameter of a device allowed to control a port, such as hardware information, including a central processing unit address cpuid and a mainboard serial number serialNumber.
S2: Store the predetermined device parameter in a structure variable.
S3: Generate character string data in a utf-8 format through data interchange format json parsing, and then convert the character string data into a byte array in the utf-8 format.
S4: Generate a binary array of utf-8 through encryption by using an advanced encryption standard AES algorithm key 2 (key2), and then convert the binary array into data in a base64 binary format including a series of predetermined device parameters of the device.
S5: Form a structure including the predetermined device parameter, and generate json character string data in the utf-8 format through json parsing.
S6: Generate binary data of utf-8 after conversion, perform encoding by using an AES algorithm key 1 (key1), generate an encrypted use certificate, and transmit the use certificate to the device allowed to control the port.

After the use certificate is created, steps of the verification process may be performed. The verification process is described below by using an example.

In a case that the target device is the device allowed to control the port,
S1: Obtain an encrypted use certificate.
S2: Perform parsing using an AES algorithm key 1 to obtain binary data in a utf-8 format.
S3: Perform utf8 encoding on the binary data of utf-8 to obtain binary data in the utf-8 format.
S4: Perform json parsing on json character string data, to obtain a structure forming hardware information.
S5: Decrypt into the foregoing structure by using an AES algorithm key 2 (key2), and then convert into a byte array in the utf-8 format.
S6: Obtain character string data in the utf-8 format by using the byte array in the utf-8 format, obtain a structure including a predetermined device parameter through json parsing, obtain a device parameter of a device allowed to control a port from the structure, compare with a target device parameter of a target device, and authorize to enter software to control the port if the parameters are consistent.

As an optional embodiment, before receiving a predetermined operation of a target object on a target control in an operation interface, the method further includes: obtaining module information corresponding to the target module and device information corresponding to the measurement device; configuring, according to the module information corresponding to the target module, the target module port corresponding to the target module, and configuring, according to the device information corresponding to the measurement device, the virtual module port corresponding to the measurement device; and obtaining the plurality of port groups according to the target module port corresponding to the target module and the virtual module port corresponding to the measurement device.

In this optional embodiment, a process of first arranging a plurality of port groups is disclosed. By using the plurality of port groups, data of a plurality of channels may be simultaneously acquired in real time. In addition, when the data is simultaneously obtained through the foregoing plurality of channels, since a target module port and a virtual module port are bound and matched (are both placed in one port group), a problem that a user cannot clearly know a corresponding data port and a corresponding data channel, a table for storing the acquired data, or a mode of acquiring and presenting the data through channel separation can be solved.

The process of arranging a port group is described below by using an example.

A unique number, for example, cp2102, is set for a target module port such as a port corresponding to a hardware communication module. A unique number, for example, 1, is set for a virtual module port such as a port corresponding to a vibration data acquisition module corresponding to a vibration sensor on a reduction gearbox. In this case, one port group includes cp2102 and 1. To be specific, the target module may be bound to the vibration data acquisition module corresponding to the vibration sensor on the reduction gearbox, and it can be learned, by using 1 and/or cp2102, that the vibration data acquisition module corresponding to the vibration sensor on the reduction gearbox acquires data under the control of the target module, and it can be learned that the acquired data is vibration data corresponding to the vibration sensor on the reduction gearbox.

It should be noted that a label may be adhered to the hardware i.e. the target module. For example, a label of “port 1” is adhered to identify and distinguish the hardware. To be specific, the information may further be recorded in the port group. The three types of data exist in the port group, so that the hardware and the software can be bound and distinguished.

When a plurality of target modules are simultaneously inserted, all the target modules may be opened and used by using a one-click function, where the same operation is performed on all the ports by one click, or different operations are performed on all the ports through different settings. Multi-port concurrent communication, simultaneous data obtaining of a plurality of ports, data displaying, and the like may be implemented by using a thread pool and a multi-thread scheduling mechanism.

According to this embodiment, a corresponding relationship between a target module and a virtual module can be very clearly and intuitively presented, so that a situation in which a plurality of port modules cannot be used simultaneously and hardware and data are in confusion is solved. The number of port modules may be changed flexibly, and the number of virtual channels opened may be determined according to the number of port modules that are inserted and removed, thereby solving a situation in which data cannot be acquired concurrently through a plurality of channels by one click so that the data can be acquired through only one channel.

As an optional embodiment, before receiving a predetermined operation of a target object on a target control in an operation interface, the method further includes: receiving historical reciprocating device data transmitted by a predetermined storage device and corresponding to the plurality of port groups.

In this optional embodiment, how to obtain data in a bad network communication situation is considered. Since there is a possibility that an operation site using the reciprocating device is in a wilderness area, or in a desolate area, in this site, network communication is generally bad. Based on this situation, a good network status and a situation in which the network status is bad or there is no network connection may be divided. When the network status is good, data may be acquired in real time and displayed for analysis. When the network status is bad or there is no network connection, the data may be first stored in a predetermined storage device, and after the data is stored, the data is intensively analyzed when the network status is good. In addition, a server program does not need to write code to indirectly access data in a database, thereby reducing a large quantity of code, developing difficulty and cycles, and improving flexibility. The embodiment is suitable for use in many cases.

It should be noted that when too much data is stored in a predetermined storage device, data that lasts for the longest time may be deleted.

As an optional embodiment, the step of receiving, in a case that the target device parameter is consistent with a predetermined device parameter, a use permission instruction transmitted by the target server includes: obtaining a current time; and receiving, in a case that the current time falls within a use permission time range and the target device parameter is consistent with the predetermined device parameter, the use permission instruction transmitted by the target server.

In this optional embodiment, a permitted time for use is further set, thereby strengthening protection against security. For example, as described in the foregoing optional implementation, in step S5 in the creation process, date and time for authorization may be added, to form a structure of the predetermined device parameter and the authorization date, and json character string data in a utf-8 format is generated through json parsing. In S6 in the verification process, character string data in the utf-8 format can be obtained by using the byte array in the utf-8 format, a structure including a predetermined device parameter is obtained through json parsing, a device parameter of a device allowed to control a port is obtained from the structure, the parameter is compared with a target device parameter of a target device, and whether current time falls within the authorization date is checked. It may be authorized to enter software to control the port if the parameters are consistent and the current time falls within the authorization time. Dual protection on time and devices is implemented.

As an optional embodiment, the method further includes: determining, according to the reciprocating device data corresponding to the plurality of port groups, a fault result indicating whether the reciprocating device is faulty.

In this optional embodiment, after data of a corresponding reciprocating device is displayed on a display interface, the data may further be analyzed. For example, an eigenvalue computing sub-module, a time-domain to frequency-domain algorithm sub-module, an envelope diagram algorithm sub-module, a key-phase signal diagram algorithm sub-module, a vibration signal angle-domain algorithm sub-module, an angle-domain envelope diagram algorithm sub-module, and an angle-domain histogram algorithm sub-module may be included, so as to analyze different data separately and obtain, through prediction, a fault result indicating whether the reciprocating device is faulty.

For example, the eigenvalue computing sub-module computes, according to original data of vibration, various eigenvalues, such as a total value, a sum, an average value, a variance, a standard deviation, a slope, a kurtosis coefficient, a maximum value, a minimum value, a median, a peak-to-peak value, a vertex, and a minimum point. The original data is processed according to running of the device, to obtain a trend value in a time period. A situation of the time interval is reflected.

The envelope diagram algorithm sub-module adopts envelope diagram algorithm steps, including: filtering, Hilbert transform, and FFT. For the vibration, after a target signal is filtered by using a Butterworth filter, Hilbert transformation is performed to obtain a parsed signal. The Hilbert transform is implemented by using a frequency-domain method. The parsed signal is a complex number, an envelope waveform is obtained after a modulo operation, and a spectrum is obtained after the FFT. Data analysis is implemented in a spectrum mode.

Optionally, the foregoing data or prediction result may further be outputted to a visual module (in a form of a chart). For example, for convenience of checking a fault situation, data in a period of time may be flexibly selected. Then, one type of data may be selected based on multiple algorithm modules in an intelligent analysis module, or multiple types of data may be selected at the same time for data processing. By checking the effect of chart presentation, problems of the vibration data may be seen, a problem of the reciprocating device may be presented and handled, and crude data may be presented in a form of a chart more intuitively, so that a problem is better found or a trend of the reciprocating device is predicted.

It can be seen that in an optional embodiment of this application, by using the port groups, all ports can be opened and operated by one click, and all the opened ports can be concurrently operated by multiple threads without affecting each other. In addition, direct connection to a server, an industrial personal computer, an external controller, and a sensor is supported, two modes, i.e. big data volume analysis and real-time data analysis, are satisfied, and a working scenario with the Internet and a working scenario without the Internet are satisfied. During use, the authorization method may be decrypted based on time and hardware characteristics, and the time may be based on an industrial personal computer or a server, to prevent modification. Finally, analysis on the data of the reciprocating device is further included, and an algorithm of the intelligent analysis module and a visual chart are used for presentation, to facilitate analysis.

It should be noted that to simplify the description, the foregoing method embodiments are described as a series of action combinations. But a person of ordinary skill in the art may know that the present disclosure is not limited to any described sequence of actions, as some steps may be executed in other sequences or simultaneously according to the present disclosure. Furthermore, a person skilled in the art will also recognize that the embodiments described in the specification belong to exemplary embodiments and that the acts and modules involved are not necessarily required of the present disclosure.

According to the descriptions in the foregoing implementations, a person skilled in the art may clearly learn that the method according to the foregoing embodiments may be implemented by relying on software and a commodity hardware platform or by using hardware. Based on this understanding, the technical solution of the present disclosure essentially or in part contributing to the related art may be embodied in the form of a software product stored in a storage medium (e.g., a read-only memory (ROM)/a random access memory (RAM), a magnetic disk, or an optical disc), including several instructions for causing a terminal device (which may be a mobile phone, a computer, a server, or a network device) to perform the method in the embodiments of the present disclosure.

### Embodiment 2

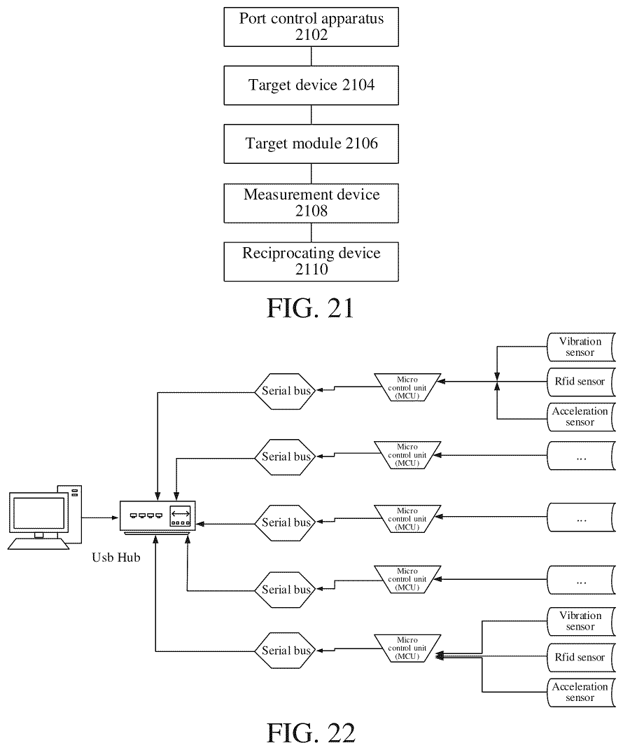

According to this embodiment of the present disclosure, a system configured to implement the foregoing port control method is further provided. FIG. 21 is an example structural block diagram of a port control system according to an embodiment of the present disclosure. As shown in FIG. 21, the system includes: a port control apparatus 2102, a target device 2104, a target module 2106, a measurement device 2108, and a reciprocating device 2110. The port control apparatus 2102 is connected to the target device 2104. The target device 2104 is connected to the target module 2106. The target module 2106 is connected to the measurement device 2108. The measurement device 2108 is connected to the reciprocating device 2110. By using the system, content recorded in the foregoing port control method can be implemented.

Optionally, FIG. 22 is a connection architecture diagram according to an optional embodiment of the present disclosure. As shown in FIG. 22, a connection architecture of a port control system is shown. The connection architecture includes a target device, a usb extension interface, a target module, a controller, and a sensing device, so that the target device can be connected to a plurality of target modules through extension by using the usb extension interface. Different controllers or sensing devices may be correspondingly connected to the target modules, to obtain corresponding data, thereby implementing the content recorded in the foregoing port control method.

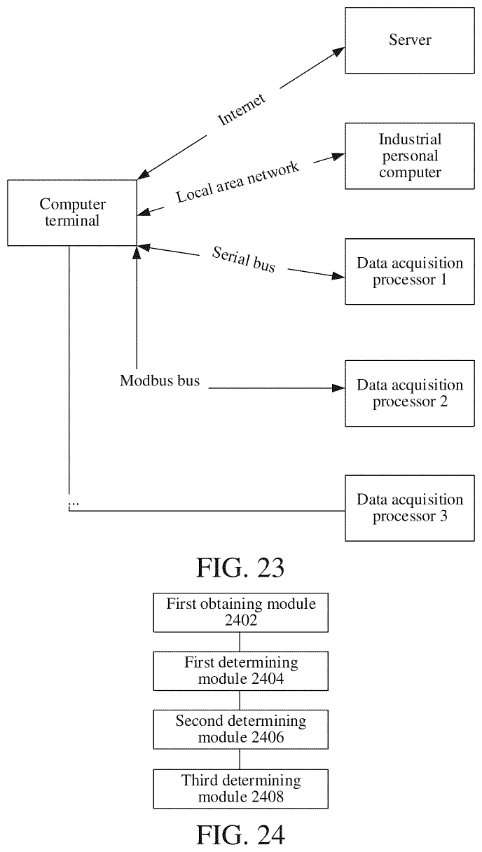

FIG. 23 is an example schematic diagram of multi-terminal connection according to an optional embodiment of the present disclosure. As shown in FIG. 23, a connection relationship between hardware may present the foregoing relationship, to implement the content recorded in the foregoing port control method.

### Embodiment 3

According to this embodiment of the present disclosure, an apparatus configured to implement the foregoing first fault determining method of the reciprocating device is further provided. FIG. 24 is an example structural block diagram of a first fault determining apparatus of a reciprocating device according to an embodiment of the present disclosure. As shown in FIG. 24, the apparatus includes: a first obtaining module 2402, a first determining module 2404, a second determining module 2406, and a third determining module 2408. The following describes the apparatus in detail.

The first obtaining module 2402 is configured to obtain target signal data, where the target signal data is acquired by a sensor located on a component at a predetermined location of a reciprocating device. The first determining module 2404 is connected to the first obtaining module 2402 and is configured to determine a target processing mode according to a data type of the target signal data. The second determining module 2406 is connected to the first determining module 2404 and is configured to process the target signal data according to the target processing mode, to obtain a running status eigenvalue reflecting a running status of the component at the predetermined location of the reciprocating device. The third determining module 2408 is connected to the second determining module 2406 and is configured to process, according to the running status eigenvalue, a fault result indicating whether the component at the predetermined location of the reciprocating device is faulty.

It should be noted herein that the first obtaining module 2402, the first determining module 2404, the second determining module 2406, and the third determining module 2408 correspond to step S102 to step S108 in the fault determining method of the reciprocating device. An example and an application scenario implemented by the plurality of modules are the same as those implemented by the corresponding steps, but are not limited to the content disclosed in Embodiment 1.

### Embodiment 4

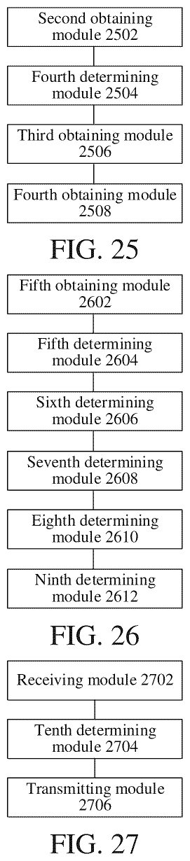

According to this embodiment of the present disclosure, an apparatus configured to implement the foregoing second fault determining method is further provided. FIG. 25 is an example structural block diagram of a second fault determining apparatus of a reciprocating device according to an embodiment of the present disclosure. As shown in FIG. 25, the apparatus includes: a second obtaining module 2502, a fourth determining module 2504, a third obtaining module 2506, and a fourth obtaining module 2508. The following describes the apparatus in detail.

The second obtaining module 2502 is configured to obtain target data of a reciprocating device corresponding to a target strain association indicator within a target stage in a current working status, and predetermined data of the reciprocating device corresponding to the target strain association indicator within the target stage in a predetermined working status, where the target stage includes at least one of the following: a compression stage and an expansion stage. The fourth determining module 2504 is connected to the second obtaining module 2502 and is configured to determine a target deviation value according to the target data and predetermined data. The third obtaining module 2506 is connected to the fourth determining module 2504 and is configured to compare the target deviation value with a predetermined deviation threshold, to obtain a target deviation comparison result, where the predetermined deviation threshold is determined according to the target stage. The fourth obtaining module 2508 is connected to the third obtaining module 2506 and is configured to obtain, according to the target deviation comparison result and a target comparison relationship, a target fault determining result indicating whether the reciprocating device is faulty, where the target comparison relationship represents a comparison relationship between a deviation comparison result and a fault determining result.

It should be noted herein that the second obtaining module 2502, the fourth determining module 2504, the third obtaining module 2506, and the fourth obtaining module 2508 correspond to step S702 to step S708 in the fault determining method. An example and an application scenario implemented by the plurality of modules are the same as those implemented by the corresponding steps, but are not limited to the content disclosed in Embodiment 1.

### Embodiment 5

According to this embodiment of the present disclosure, an apparatus configured to implement the foregoing third fault determining method of the reciprocating device is further provided. FIG. 26 is an example structural block diagram of a third fault determining apparatus of a reciprocating device according to an embodiment of the present disclosure. As shown in FIG. 26, the apparatus includes: a fifth obtaining module 2602, a fifth determining module 2604, a sixth determining module 2606, a seventh determining module 2608, an eighth determining module 2610, and a ninth determining module 2612. The following describes the apparatus in detail.

The fifth obtaining module 2602 is configured to obtain target key-phase data and target vibration data of at least one cycle of a reciprocating device, where the target vibration data is acquired by a sensor located on a component at a predetermined location of the reciprocating device, and the target key-phase data includes a target key-phase signal value. The fifth determining module 2604 is connected to the fifth obtaining module 2602 and is configured to determine a first comparison relationship according to the target key-phase data, where the first comparison relationship is configured for representing a corresponding relationship between time and a key-phase signal value.

The sixth determining module 2606 is connected to the fifth determining module 2604 and is configured to determine a second comparison relationship according to the target vibration data and the first comparison relationship, where the second comparison relationship is configured for representing a corresponding relationship between an angle by which an internal gear of the reciprocating device rotates and an amplitude of the component at the predetermined location.

The seventh determining module 2608 is connected to the sixth determining module 2606 and is configured to determine, according to the second comparison relationship, an angle-domain histogram and an angle-domain envelope diagram corresponding to the reciprocating device.

The eighth determining module 2610 is connected to the seventh determining module 2608 and is configured to determine a target number of columnar objects having height values exceeding a predetermined threshold in the angle-domain histogram and a target envelope area in the angle-domain envelope diagram.

The ninth determining module 2612 connected to the eighth determining module 2610 is configured to determine, according to the target number and the target envelope area, a fault result indicating whether the reciprocating device is faulty.

It should be noted herein that the fifth obtaining module 2602, the fifth determining module 2604, the sixth determining module 2606, the seventh determining module 2608, the eighth determining module 2610, and the ninth determining module 2612 correspond to step S1202 to step S1212 in the fault determining method of the reciprocating device. An example and an application scenario implemented by the plurality of modules are the same as those implemented by the corresponding steps, but are not limited to the content disclosed in Embodiment 1.

### Embodiment 6

According to this embodiment of the present disclosure, an apparatus configured to implement the foregoing port control method is further provided. FIG. 27 is an example structural block diagram of a port control apparatus according to an embodiment of the present disclosure. As shown in FIG. 27, the apparatus includes: a receiving module 2702, a tenth determining module 2704, and a transmitting module 2706. The following describes the apparatus in detail.

The receiving module 2702 is configured to receive a predetermined operation of a target object on a target control in an operation interface, where the operation interface displays reciprocating device data corresponding to a plurality of port groups and controls controlling ports within the plurality of port groups, and the port group includes a target module port corresponding to a target module inserted into a target device and a virtual module port corresponding to a measurement device connected to the target module. The tenth determining module 2704 is connected to the receiving module 2702 and is configured to determine, in response to the predetermined operation, a target port group the target control and a target control instruction for controlling the target port group. The transmitting module 2706 is connected to the tenth determining module 2704 and is configured to transmit the target control instruction to the target port group.

It should be noted herein that the receiving module 2702, the tenth determining module 2704, and the transmitting module 2706 correspond to step S2002 to step S2006 in the port control method. An example and an application scenario implemented by the plurality of modules are the same as those implemented by the corresponding steps, but are not limited to the content disclosed in Embodiment 1.

### Embodiment 7

According to another aspect of this embodiment of the present disclosure, an electronic device is further provided, including: a processor; and a memory configured to store instructions executable by the processor, where the processor is configured to execute the instructions, to implement the fault determining method of the reciprocating device and the port control method according to any of the foregoing.

### Embodiment 8

According to another aspect of the embodiments of the present disclosure, a computer-readable storage medium is further provided. When instructions in the computer-readable storage medium are executed by a processor of an electronic device, the electronic device is caused to perform the fault determining method of the reciprocating device and the port control method according to any of the foregoing.

The sequence numbers of the embodiments of the present disclosure are merely for the description purpose but do not imply the preference among the embodiments.

In the foregoing embodiments of the present disclosure, the descriptions of the embodiments have different focuses. For a part that is not detailed in an embodiment, refer to the relevant description of other embodiments.

In several embodiments provided in this application, it should be understood that the disclosed technical content may be implemented otherwise. The apparatus embodiments described above are merely examples. For example, division into the units is merely logical function division, and may be another division in an actual implementation. For example, a plurality of units or assemblies may be combined or integrated into another system, or some features may be ignored or not be performed. In addition, the coupling, or direct coupling, or communication connection between the displayed or discussed components may be the indirect coupling or communication connection by means of some interfaces, units, or modules, and may be electrical or of other forms.

The units described as separate components may or may not be physically separated. The components displayed as units may or may not be physical units, and may be located in one place or may be distributed over a plurality of network units. Some or all of the units may be selected according to actual needs to achieve the objectives of the solutions of the embodiments.

In addition, functional units in the embodiments of the present disclosure may be integrated into one processing unit, or each of the units may be physically separated, or two or more units may be integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on this understanding, the technical solution of the present disclosure essentially or in part contributing to the related art or all or part of the technical solution may be embodied in the form of a software product stored in a storage medium, including several instructions for causing a computer device (which may be a personal computer, a server, or a network device) to perform all or part of the steps of the method described in the embodiments of the present disclosure. The foregoing storage medium includes: a USB flash drive, a ROM, a RAM, a mobile hard disk, a magnetic disk, or an optical disc, and other media which may store program codes.

The foregoing descriptions are exemplary implementations of the present disclosure. It should be noted that a person of ordinary skill in the art may make some improvements and modifications without departing from the principle of the present disclosure and the improvements and modifications shall fall within the protection scope of the present disclosure.

### INDUSTRIAL APPLICABILITY

Solutions provided in this application may be applied to the field of reciprocating devices. In the embodiments of this application, target signal data is obtained, where the target signal data is acquired by a sensor located on a component at a predetermined location of a reciprocating device. A target processing mode is determined according to a data type of the target signal data. The target signal data is processed according to the target processing mode, to obtain a running status eigenvalue reflecting a running status of the component at the predetermined location of the reciprocating device. According to the running status eigenvalue, a fault result indicating whether the component at the predetermined location of the reciprocating device is faulty is determined. The present disclosure solves a technical problem that it is unlikely to accurately determine a fault of a reciprocating device in the related art, and achieves a technical effect of accurately determining the fault of the reciprocating device.

What is claimed is:

1. A fault determining method of a reciprocating device, comprising:
obtaining target signal data acquired by a sensor located on a component at a predetermined location of a reciprocating device;
determining, according to a data type of the target signal data, a target processing mode;
processing, according to the target processing mode, the target signal data, to obtain a running status eigenvalue reflecting a running status of the component; and
determining, according to the running status eigenvalue, a fault result indicating whether the component is faulty.

2. The method according to claim 1, wherein, after the processing the target signal data, the method further comprises:
processing the running status eigenvalue by reduction of dimensionality, to obtain a use duration eigenvalue reflecting a remaining use duration of the component; and
determining, according to the use duration eigenvalue, the remaining use duration of the component.

3. The method according to claim 1, wherein processing the target signal data comprises:
in a case that the target signal data comprises key-phase data and vibration time-domain signal data, the data type of the target signal data comprises a key-phase data type and a vibration time-domain signal data type, and the target processing mode is a predetermined data type conversion processing mode,
converting the vibration time-domain signal data, to obtain vibration angle-domain signal data in which a data type is a vibration angle-domain signal data type; and
obtaining, according to the key-phase data and the vibration angle-domain signal data, the running status eigenvalue reflecting the running status of the component.

4. The method according to claim 1, wherein processing the target signal data comprises:
in a case that the target processing mode is a model processing mode,
inputting the target signal data to a status detection model obtained by training an initial model by using sample data comprising sample signal data and a sample running status eigenvalue, to obtain the running status eigenvalue reflecting the running status of the component.

5. The method according to claim 1, wherein processing the target signal data comprises:
in a case that the target processing mode is a baseline space processing mode,
determining a difference distribution between the target signal data and a predetermined baseline space; and
obtaining, according to the difference distribution, the running status eigenvalue reflecting the running status of the component.

6. The method according to claim 1, wherein obtaining, according to target digital signal data, the running status eigenvalue reflecting the running status of the component comprises:
in a case that the target digital signal data comprises vibration frequency signal data and the target processing mode is a filtering processing mode,
filtering the vibration frequency signal data according to a predetermined mode comprising a band-pass filtering mode and a windowing function filtering mode, to obtain the running status eigenvalue reflecting the running status of the component.

7. The method according to claim 1, wherein the sensor located on the component comprises at least one of the following:
a first vibration sensor located on a rotating component of the reciprocating device,
a second vibration sensor located on a crankcase bearing housing of the reciprocating device,
a temperature-vibration integral sensor located in a cross head load region of the reciprocating device,
a key-phase sensor located on a power end crankshaft of the reciprocating device and/or a rotating component linked to the power end crankshaft, and
a pressure sensor located on a gland of the reciprocating device.

8. A fault determining method of a reciprocating device, comprising:
obtaining:
target data of the reciprocating device corresponding to a target strain association indicator within a target stage in a current working status, and
predetermined data of the reciprocating device corresponding to the target strain association indicator within the target stage in a predetermined working status,
wherein the target stage comprises at least one of a compression stage and an expansion stage;
determining, according to the target data and the predetermined data, a target deviation value;
comparing the target deviation value with a predetermined deviation threshold determined according to the target stage, to obtain a target deviation comparison result; and
obtaining, according to the target deviation comparison result and a target comparison relationship representing a comparison relationship between a deviation comparison result and a fault determining result, a target fault determining result indicating whether the reciprocating device is faulty.

9. The method according to claim 8, wherein obtaining the target data of the reciprocating device comprises:
obtaining first key-phase data of the reciprocating device in the current working status and initial data corresponding to the target strain association indicator;
preprocessing the initial data, to obtain first data, and preprocessing the first key-phase data, to obtain a target key-phase signal;
determining, according to the target key-phase signal, a target index value;
obtaining, according to the target index value and the first data, second data corresponding to a plurality of predetermined cycles, wherein each of the plurality of predetermined cycles comprises a compression stage, a discharge stage, an expansion stage, and a suction stage; and
obtaining, according to second data corresponding to a target cycle, the target data of the reciprocating device, wherein the target cycle is any of the plurality of predetermined cycles.

10. The method according to claim 8, wherein obtaining the predetermined data of the reciprocating device comprises:
determining a target working condition of the reciprocating device in the current working status, and obtaining a target matrix of the reciprocating device corresponding to the target strain association indicator in the predetermined working status, wherein the target matrix comprises data corresponding to a plurality of running working conditions; and
obtaining, from the target matrix, predetermined data of the reciprocating device wherein the predetermined data is data corresponding to the target working condition in the target matrix.

11. The method according to claim 10, wherein obtaining the target matrix of the reciprocating device comprises:
obtaining, for the reciprocating device in the predetermined working status,
a plurality of second key-phase data corresponding to a plurality of working conditions, and
a plurality of third data corresponding to the target strain association indicator,
wherein the plurality of third data is data corresponding to the plurality of working conditions, and the plurality of working conditions is in a one-to-one correspondence with the plurality of second key-phase data;
preprocessing the plurality of third data, to obtain a plurality of fourth data, and preprocessing the plurality of second key-phase data, to obtain a plurality of predetermined key-phase data;
determining, according to the plurality of predetermined key-phase data, a plurality of predetermined index values;
obtaining, according to the plurality of predetermined index values and the plurality of fourth data, a plurality of fifth data corresponding to a target cycle, wherein the target cycle comprises: a compression stage, a discharge stage, an expansion stage, and a suction stage, and the plurality of fifth data is in a one-to-one correspondence with the plurality of working conditions; and
determining, according to the plurality of fifth data, the target matrix.

12. The method according to claim 8, wherein determining the target deviation value comprises:
in a case that the target stage comprises the compression stage,
determining, according to the target data, the predetermined data, and a target formula, the target deviation value representing a degree of phase separation between the target data and the predetermined data.

13. The method according to claim 8, wherein determining the target deviation value comprises:
in a case that the target stage comprises the expansion stage,
obtaining device running data of the reciprocating device in the current working status;
determining a first index value corresponding to the target data and a second index value corresponding to the predetermined data; and
determining, according to the first index value, the second index value, and the device running data, the target deviation value representing a degree of phase angle separation between the target data and the predetermined data.

14. The method according to claim 8, wherein, after obtaining the target fault determining result, the method further comprises:
in a case that the target fault determining result is that the reciprocating device is faulty in the current working status,
transmitting alarm information to a predetermined terminal.

15. A fault determining method of a reciprocating device, comprising:
obtaining:
target key-phase data comprising a target key-phase signal value, and
target vibration data of at least one cycle of a reciprocating device,
wherein the target vibration data is acquired by a sensor located on a component at a predetermined location of the reciprocating device;
determining, according to the target key-phase data, a first comparison relationship configured for representing a corresponding relationship between time and a key-phase signal value;
determining, according to the target vibration data and the first comparison relationship, a second comparison relationship configured for representing a corresponding relationship between an angle by which an internal gear of the reciprocating device rotates and an amplitude of the component at the predetermined location;
determining, according to the second comparison relationship, an angle-domain histogram and an angle-domain envelope diagram corresponding to the reciprocating device;
determining:
a target number of columnar objects having height values exceeding a predetermined threshold in the angle-domain histogram, and
a target envelope area in the angle-domain envelope diagram; and
determining, according to the target number and the target envelope area, a fault result indicating whether the reciprocating device is faulty.

16. The method according to claim 15, wherein determining the angle-domain histogram comprises:
determining first angle numbers for generating the angle-domain histogram;
determining, according to the second comparison relationship, an average amplitude value corresponding to each first angle number within a predetermined angle range; and
determining, according to the average amplitude value, the angle-domain histogram corresponding to the reciprocating device.

17. The method according to claim 15, wherein determining the angle-domain envelope diagram comprises:
determining second angle numbers for generating the angle-domain envelope diagram;
determining, according to the second comparison relationship, a maximum amplitude value and a minimum amplitude value corresponding to each second angle number within a predetermined angle range; and
determining, according to the maximum amplitude value and the minimum amplitude value corresponding to each second angle number within the predetermined angle range, the angle-domain envelope diagram corresponding to the reciprocating device.

18. The method according to claim 17, wherein determining the angle-domain envelope diagram comprises:
transforming, according to a Hilbert transform method, the maximum amplitude value and the minimum amplitude value corresponding to each second angle number within the predetermined angle range, to obtain an envelope value corresponding to each second angle number within the predetermined angle range; and
determining, according to the envelope value, the angle-domain envelope diagram corresponding to the reciprocating device.

19. The method according to claim 15, wherein, after determining the fault result, the method further comprises:
in a case that the target vibration data comprises a plurality of target vibration, and the fault result is that the reciprocating device is faulty,
determining, according to the target vibration data, a fault location of the reciprocating device.

20. The method according to claim 15, wherein, before obtaining the target key-phase data and the target vibration data of at least one cycle of the reciprocating device, the method further comprises:
obtaining initial key-phase data and initial vibration data of at least one cycle of the reciprocating device; and
filtering the initial key-phase data and the initial vibration data, to obtain the target key-phase data and the target vibration data of the at least one cycle of the reciprocating device.
